(19) United States
(12) Patent Application Publication
(10) Pub. No.: US 2025/0287401 A1
(43) Pub. Date: Sep. 11, 2025

(54) USER EQUIPMENT AND COMMUNICATION METHODS

(71) Applicant: SHARP KABUSHIKI KAISHA, Sakai City, Osaka (JP)

(72) Inventors: LIQING LIU, Sakai City, Osaka (JP); DAIICHIRO NAKASHIMA, Sakai City, Osaka (JP); WATARU OUCHI, Sakai City, Osaka (JP); SHOICHI SUZUKI, Sakai City, Osaka (JP)

(21) Appl. No.: 18/858,930

(22) PCT Filed: Apr. 25, 2023
(86) PCT No.: PCT/JP2023/017097

§ 371 Date: Oct. 22, 2024

(30) Foreign Application Priority Data
Apr. 26, 2022 (JP) 2022-072435

(51) Int. Cl. H04W 72/25; H04L 5/00; H04W 72/0453

(52) U.S. Cl. CPC H04W 72/25; H04L 5/0055; H04W 72/0453

(57) ABSTRACT

A method by a user equipment (UE) is described. The method includes receiving, from another UE, a physical sidelink shared channel (PSSCH) with interlaced transmission, the PSSCH being allocated with one or more resource block (RB) sets and one or more interlaces in frequency domain; and determining, a physical sidelink feedback channel (PSFCH) resource for a HARQ feedback transmission in response to the reception of the PSSCH, wherein the PSFCH resource in frequency domain corresponds to an interlace and an RB set and is determined by using a lowest RB set index amongst the one or more RB sets and a lowest interlace index amongst the one or more interlaces.

### TECHNICAL FIELD

The present disclosure relates to a user equipment, and a communication method.

### BACKGROUND ART

At present, as a radio access system and a radio network technology aimed for the fifth generation cellular system, technical investigation and standard development are being conducted, as extended standards of Long Term Evolution (LTE), on LTE-Advanced Pro (LTE-A Pro) and New Radio technology (NR) in The Third Generation Partnership Project (3GPP).

In the fifth generation cellular system, three services of enhanced Mobile BroadBand (eMBB) to achieve high-speed and large-volume transmission, Ultra-Reliable and Low Latency Communication (URLLC) to achieve low-latency and high-reliability communication, and massive Machine Type Communication (mMTC) to allow connection of a large number of machine type devices such as Internet of Things (IoT) have been demanded as assumed scenarios.

For example, wireless communication devices may communicate with one or more device. For sidelink communication, two communication devices can communicate with each other via PC-5 interface. However, given the existing sidelink communication methods can not directly applied to unlicensed spectrum, the flexibility and/or the efficiency of the whole sidelink communication system would be limited. As illustrated by this discussion, systems and methods according to the present invention, supporting HARQ feedback transmission and reception on PSFCH over unlicensed spectrum, which may improve the communication flexibility and/or efficiency, would be beneficial.

### BRIEF DESCRIPTION OF THE DRAWINGS

FIG. 1 is a block diagram illustrating one configuration of one or more base stations and one or more user equipments (UEs) in which systems and methods for interlaced PSFCH transmission may be implemented;

FIG. 2 is a diagram illustrating one example 200 of a resource grid;

FIG. 3 is a diagram illustrating one example 300 of common resource block grid, carrier configuration and BWP configuration by a UE 102 and a base station 160;

FIG. 4 is a diagram illustrating one 400 example of CORESET configuration in a BWP by a UE 102 and a base station 160;

FIG. 5 is a diagram illustrating one example 500 for interlaced resource blocks for transmission and reception;

FIG. 6 is a diagram illustrating one example 600 of interlaced mapping for a BWP;

FIG. 7 is a diagram illustrating one example 700 of a SL BWP and a resource pool within the SL BWP;

FIG. 8 is a diagram illustrating one example 800 of a resource pool configuration;

FIG. 9 is a diagram illustrating one example 900 of PSSCH allocation in a resource pool;

FIG. 10 is a flow diagram illustrating one implementation of a method 1000 for determine a PSFCH resource for HARQ feedback transmission by a UE 102;

FIG. 11 is a flow diagram illustrating one implementation of a method 1100 for determine a PSFCH resource for HARQ feedback reception by a UE 102;

FIG. 12 illustrates various components that may be utilized in a UE;

FIG. 13 illustrates various components that may be utilized in a base station;

### DESCRIPTION OF EMBODIMENTS

A user equipment (UE) is described. The UE includes reception circuitry configured to receive, from another UE, a physical sidelink shared channel (PSSCH) with interlaced transmission, the PSSCH being allocated with one or more resource block (RB) sets and one or more interlaces in frequency domain; and control circuitry configured to determine, a physical sidelink feedback channel (PSFCH) resource for a HARQ feedback transmission in response to the reception of the PSSCH, wherein the PSFCH resource in frequency domain corresponds to an interlace and an RB set and is determined by using a lowest RB set index amongst the one or more RB sets and a lowest interlace index amongst the one or more interlaces.

A user equipment (UE) is described. The UE includes transmission circuitry configured to transmit, to another UE, a physical sidelink shared channel (PSSCH) with interlaced transmission, the PSSCH being allocated with one or more resource block (RB) sets and one or more interlaces in frequency domain; and control circuitry configured to determine, a physical sidelink feedback channel (PSFCH) resource for a HARQ feedback reception in response to the transmission of the PSSCH, wherein the PSFCH resource in frequency domain corresponds to an interlace and an RB set and is determined by using a lowest RB set index amongst the one or more RB sets and a lowest interlace index amongst the one or more interlaces.

A communication method by a user equipment (UE) is described. The method includes receiving, from another UE, a physical sidelink shared channel (PSSCH) with interlaced transmission, the PSSCH being allocated with one or more resource block (RB) sets and one or more interlaces in frequency domain; and determining, a physical sidelink feedback channel (PSFCH) resource for a HARQ feedback transmission in response to the reception of the PSSCH, wherein the PSFCH resource in frequency domain corresponds to an interlace and an RB set and is determined by using a lowest RB set index amongst the one or more RB sets and a lowest interlace index amongst the one or more interlaces.

A communication method by a user equipment (UE) is described. The method includes transmitting, to another UE, a physical sidelink shared channel (PSSCH) with interlaced transmission, the PSSCH being allocated with one or more resource block (RB) sets and one or more interlaces in frequency domain; and determining, a physical sidelink feedback channel (PSFCH) resource for a HARQ feedback reception in response to the transmission of the PSSCH, wherein the PSFCH resource in frequency domain corresponds to an interlace and an RB set and is determined by using a lowest RB set index amongst the one or more RB sets and a lowest interlace index amongst the one or more interlaces.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN). 3GPP NR (New Radio) is the name given to a project to improve the LTE mobile phone or device standard to cope with future requirements. In one aspect, LTE has been modified to provide support and specification (TS 38.331, 38.321, 38.300, 37.340, 38.211, 38.212, 38.213, 38.214, etc.) for the New Radio Access (NR) and Next generation-Radio Access Network (NG-RAN).

At least some aspects of the systems and methods disclosed herein may be described in relation to the 3GPP LTE, LTE-Advanced (LTE-A), LTE-Advanced Pro, New Radio Access (NR), and other 3G/4G/5G standards (e.g., 3GPP Releases 8, 9, 10, 11, 12, 13, 14, 15, and/or 16, and/or Narrow Band-Internet of Things (NB-IoT)). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE (User Equipment), an access terminal, a subscriber station, a mobile terminal, a remote station, a user terminal, a terminal, a subscriber unit, a mobile device, a relay node, etc. Examples of wireless communication devices include cellular phones, smart phones, personal digital assistants (PDAs), laptop computers, netbooks, e-readers, wireless modems, industrial wireless sensors, video surveillance, wearables, vehicles, roadside units, infrastructure devices, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a gNB, a Node B, an eNB, a home enhanced or evolved Node B (HeNB) or some other similar terminology. As the scope of the disclosure should not be limited to 3GPP standards, the terms “base station,”, “gNB”, “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced), IMT-2020 (5G) and all of it or a subset of it may be adopted by 3GPP as licensed bands (e.g., frequency bands) to be used for communication between a base station and a UE. It should also be noted that in NR, NG-RAN, E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by a base station to transmit or receive information. “Configured cell(s)” may be serving cell(s). The UE may receive system information and perform the required measurements on configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The base stations may be connected by the NG interface to the 5G-core network (5G-CN). 5G-CN may be called as to NextGen core (NGC), or 5G core (5GC). The base stations may also be connected by the S1 interface to the evolved packet core (EPC). For instance, the base stations may be connected to a NextGen (NG) mobility management function by the NG-2 interface and to the NG core User Plane (UP) functions by the NG-3 interface. The NG interface supports a many-to-many relation between NG mobility management functions, NG core UP functions and the base stations. The NG-2 interface is the NG interface for the control plane and the NG-3 interface is the NG interface for the user plane. For instance, for EPC connection, the base stations may be connected to a mobility management entity (MME) by the S1-MME interface and to the serving gateway (S-GW) by the S1-U interface. The S1 interface supports a many-to-many relation between MMEs, serving gateways and the base stations. The S1-MME interface is the S1 interface for the control plane and the S1-U interface is the S1 interface for the user plane. The Uu interface is a radio interface between the UE and the base station for the radio protocol.

The radio protocol architecture may include the user plane and the control plane. The user plane protocol stack may include packet data convergence protocol (PDCP), radio link control (RLC), medium access control (MAC) and physical (PHY) layers. A DRB (Data Radio Bearer) is a radio bearer that carries user data (as opposed to control plane signaling). For example, a DRB may be mapped to the user plane protocol stack. The PDCP, RLC, MAC and PHY sublayers (terminated at the base station 460a on the network) may perform functions (e.g., header compression, ciphering, scheduling, ARQ and HARQ) for the user plane. PDCP entities are located in the PDCP sublayer. RLC entities may be located in the RLC sublayer. MAC entities may be located in the MAC sublayer. The PHY entities may be located in the PHY sublayer.

The control plane may include a control plane protocol stack. The PDCP sublayer (terminated in base station on the network side) may perform functions (e.g., ciphering and integrity protection) for the control plane. The RLC and MAC sublayers (terminated in base station on the network side) may perform the same functions as for the user plane. The Radio Resource Control (RRC) (terminated in base station on the network side) may perform the following functions. The RRC may perform broadcast functions, paging, RRC connection management, radio bearer (RB) control, mobility functions, UE measurement reporting and control. The Non-Access Stratum (NAS) control protocol (terminated in MME on the network side) may perform, among other things, evolved packet system (EPS) bearer management, authentication, evolved packet system connection management (ECM)-IDLE mobility handling, paging origination in ECM-IDLE and security control.

Signaling Radio Bearers (SRBs) are Radio Bearers (RB) that may be used only for the transmission of RRC and NAS messages. Three SRBs may be defined. SRB0 may be used for RRC messages using the common control channel (CCCH). logical channel. SRB1 may be used for RRC messages (which may include a piggybacked NAS message) as well as for NAS messages prior to the establishment of SRB2, all using the dedicated control channel (DCCH) logical channel. SRB2 may be used for RRC messages which include logged measurement information as well as for NAS messages, all using the DCCH logical channel. SRB2 has a lower-priority than SRB1 and may be configured by a network (e.g., base station) after security activation. A broadcast control channel (BCCH) logical channel may be used for broadcasting system information. Some of BCCH logical channel may convey system information which may be sent from the network to the UE via BCH (Broadcast Channel) transport channel. BCH may be sent on a physical broadcast channel (PBCH). Some of BCCH logical channel may convey system information which may be sent from the network to the UE via DL-SCH (Downlink Shared Channel) transport channel. Paging may be provided by using paging control channel (PCCH) logical channel.

For example, the DL-DCCH logical channel may be used (but not limited to) for a RRC reconfiguration message, a RRC reestablishment message, a RRC release, a UE Capability Enquiry message, a DL Information Transfer message or a Security Mode Command message. UL-DCCH logical channel may be used (but not limited to) for a measurement report message, a RRC Reconfiguration Complete message, a RRC Reestablishment Complete message, a RRC Setup Complete message, a Security Mode Complete message, a Security Mode Failure message, a UE Capability Information, message, a UL Handover Preparation Transfer message, a UL Information Transfer message, a Counter Check Response message, a UE Information Response message, a Proximity Indication message, a RN (Relay Node) Reconfiguration Complete message, an MBMS Counting Response message, an inter Frequency RSTD Measurement Indication message, a UE Assistance Information message, an In-device Coexistence Indication message, an MBMS Interest Indication message, an SCG Failure Information message. DL-CCCH logical channel may be used (but not limited to) for a RRC Connection Reestablishment message, a RRC Reestablishment Reject message, a RRC Reject message, or a RRC Setup message. UL-CCCH logical channel may be used (but not limited to) for a RRC Reestablishment Request message, or a RRC Setup Request message.

System information may be divided into the MasterInformationBlock (MIB) and a number of SystemInformationBlocks (SIBs).

The UE may receive one or more RRC messages from the base station to obtain RRC configurations or parameters. The RRC layer of the UE may configure RRC layer and/or lower layers (e.g., PHY layer, MAC layer, RLC layer, PDCP layer) of the UE according to the RRC configurations or parameters which may be configured by the RRC messages, broadcasted system information, and so on. The base station may transmit one or more RRC messages to the UE to cause the UE to configure RRC layer and/or lower layers of the UE according to the RRC configurations or parameters which may be configured by the RRC messages, broadcasted system information, and so on.

When carrier aggregation is configured, the UE may have one RRC connection with the network. One radio interface may provide carrier aggregation. During RRC establishment, re-establishment and handover, one serving cell may provide Non-Access Stratum (NAS) mobility information (e.g., a tracking area identity (TAI)). During RRC re-establishment and handover, one serving cell may provide a security input. This cell may be referred to as the primary cell (PCell). In the downlink, the component carrier corresponding to the PCell may be the downlink primary component carrier (DL PCC), while in the uplink it may be the uplink primary component carrier (UL PCC). In the present disclosure, the terms “component carrier” and “carrier” can be interchanged with each other.

Depending on UE capabilities, one or more SCells may be configured to form together with the PCell a set of serving cells. In the downlink, the component carrier corresponding to an SCell may be a downlink secondary component carrier (DL SCC), while in the uplink it may be an uplink secondary component carrier (UL SCC).

The configured set of serving cells for the UE, therefore, may consist of one PCell and one or more SCells. For each SCell, the usage of uplink resources by the UE (in addition to the downlink resources) may be configurable. The number of DL SCCs configured may be larger than or equal to the number of UL SCCs and no SCell may be configured for usage of uplink resources only.

From a UE viewpoint, each uplink resource may belong to one serving cell. The number of serving cells that may be configured depends on the aggregation capability of the UE. The PCell may only be changed using a handover procedure (e.g., with a security key change and a random access procedure). A PCell may be used for transmission of the PUCCH. A primary secondary cell (PSCell) may also be used for transmission of the PUCCH. The PSCell may be referred to as a primary SCG cell or SpCell of a secondary cell group. The PCell or PSCell may not be de-activated. Re-establishment may be triggered when the PCell experiences radio link failure (RLF), not when the SCells experience RLF. Furthermore, NAS information may be taken from the PCell.

The reconfiguration, addition and removal of SCells may be performed by RRC. At handover or reconfiguration with sync, Radio Resource Control (RRC) layer may also add, remove or reconfigure SCells for usage with a target PCell. When adding a new SCell, dedicated RRC signaling may be used for sending all required system information of the SCell (e.g., while in connected mode, UEs need not acquire broadcasted system information directly from the SCells).

The systems and methods described herein may enhance the efficient use of radio resources in Carrier aggregation (CA) operation. Carrier aggregation refers to the concurrent utilization of more than one component carrier (CC). In carrier aggregation, more than one cell may be aggregated to a UE. In one example, carrier aggregation may be used to increase the effective bandwidth available to a UE. In traditional carrier aggregation, a single base station is assumed to provide multiple serving cells for a UE. Even in scenarios where two or more cells may be aggregated (e.g., a macro cell aggregated with remote radio head (RRH) cells) the cells may be controlled (e.g., scheduled) by a single base station. However, in a small cell deployment scenario, each node (e.g., base station, RRH, etc.) may have its own independent scheduler. To maximize the efficiency of radio resources utilization of both nodes, a UE may connect to two or more nodes that have different schedulers. The systems and methods described herein may enhance the efficient use of radio resources in dual connectivity operation. A UE may be configured multiple groups of serving cells, where each group may have carrier aggregation operation (e.g., if the group includes more than one serving cell).

In Dual Connectivity (DC) the UE may be required to be capable of UL-CA with simultaneous PUCCH/PUCCH and PUCCH/PUSCH transmissions across cell-groups (CGs). In a small cell deployment scenario, each node (e.g., eNB, RRH, etc.) may have its own independent scheduler. To maximize the efficiency of radio resources utilization of both nodes, a UE may connect to two or more nodes that have different schedulers. A UE may be configured multiple groups of serving cells, where each group may have carrier aggregation operation (e.g., if the group includes more than one serving cell). A UE in RRC_CONNECTED may be configured with Dual Connectivity or MR-DC, when configured with a Master and a Secondary Cell Group. A Cell Group (CG) may be a subset of the serving cells of a UE, configured with Dual Connectivity (DC) or MR-DC, i.e. a Master Cell Group (MCG) or a Secondary Cell Group (SCG). The Master Cell Group may be a group of serving cells of a UE comprising of the PCell and zero or more secondary cells. The Secondary Cell Group (SCG) may be a group of secondary cells of a UE, configured with DC or MR-DC, comprising of the PSCell and zero or more other secondary cells. A Primary Secondary Cell (PSCell) may be the SCG cell in which the UE is instructed to perform random access when performing the SCG change procedure. “PSCell” may be also called as a Primary SCG Cell. In Dual Connectivity or MR-DC, two MAC entities may be configured in the UE: one for the MCG and one for the SCG. Each MAC entity may be configured by RRC with a serving cell supporting PUCCH transmission and contention based Random Access. In a MAC layer, the term Special Cell (SpCell) may refer to such cell, whereas the term SCell may refer to other serving cells. The term SpCell either may refer to the PCell of the MCG or the PSCell of the SCG depending on if the MAC entity is associated to the MCG or the SCG, respectively. A Timing Advance Group (TAG) containing the SpCell of a MAC entity may be referred to as primary TAG (pTAG), whereas the term secondary TAG (sTAG) refers to other TAGs.

DC may be further enhanced to support Multi-RAT Dual Connectivity (MR-DC). MR-DC may be a generalization of the Intra-E-UTRA Dual Connectivity (DC) described in 36.300, where a multiple Rx/Tx UE may be configured to utilize resources provided by two different nodes connected via non-ideal backhaul, one providing E-UTRA access and the other one providing NR access. One node acts as a Mater Node (MN) and the other as a Secondary Node (SN). The MN and SN are connected via a network interface and at least the MN is connected to the core network. In DC, a PSCell may be a primary secondary cell. In EN-DC, a PSCell may be a primary SCG cell or SpCell of a secondary cell group.

E-UTRAN may support MR-DC via E-UTRA-NR Dual Connectivity (EN-DC), in which a UE is connected to one eNB that acts as a MN and one en-gNB that acts as a SN. The en-gNB is a node providing NR user plane and control plane protocol terminations towards the UE, and acting as Secondary Node in EN-DC. The eNB is connected to the EPC via the S1 interface and to the en-gNB via the X2 interface. The en-gNB might also be connected to the EPC via the S1-U interface and other en-gNBs via the X2-U interface.

A timer is running once it is started, until it is stopped or until it expires; otherwise it is not running. A timer can be started if it is not running or restarted if it is running. A Timer may be always started or restarted from its initial value.

For NR, a technology of aggregating NR carriers may be studied. Both lower layer aggregation like Carrier Aggregation (CA) for LTE and upper layer aggregation like DC are investigated. From layer 2/3 point of view, aggregation of carriers with different numerologies may be supported in NR.

The main services and functions of the RRC sublayer may include the following:
Broadcast of System Information related to Access Stratum (AS) and Non Access Stratum (NAS);
Paging initiated by CN or RAN;
Establishment, maintenance and release of an RRC connection between the UE and NR RAN including:
Addition, modification and release of carrier aggregation;
Addition, modification and release of Dual Connectivity in NR or between LTE and NR;
Security functions including key management;
Establishment, configuration, maintenance and release of signaling radio bearers and data radio bearers;
Mobility functions including:
Handover;
UE cell selection and reselection and control of cell selection and reselection;
Context transfer at handover.
QoS management functions;
UE measurement reporting and control of the reporting;
NAS message transfer to/from NAS from/to UE.

Each MAC entity of a UE may be configured by RRC with a Discontinuous Reception (DRX) functionality that controls the UE's PDCCH monitoring activity for the MAC entity's C-RNTI (Radio Network Temporary Identifier), CS-RNTI, INT-RNTI, SFI-RNTI, SP-CSI-RNTI, TPC-PUCCH-RNTI, TPC-PUSCH-RNTI, and TPC-SRS-RNTI. For scheduling at cell level, the following identities are used:
C (Cell)-RNTI: unique UE identification used as an identifier of the RRC Connection and for scheduling;
CS (Configured Scheduling)-RNTI: unique UE identification used for Semi-Persistent Scheduling in the downlink;
INT-RNTI: identification of pre-emption in the downlink;
P-RNTI: identification of Paging and System Information change notification in the downlink;
SI-RNTI: identification of Broadcast and System Information in the downlink;
SP-CSI-RNTI: unique UE identification used for semi-persistent CSI reporting on PUSCH;
CI-RNTI: Cancellation Indication RNTI for Uplink.
   For power and slot format control, the following identities are used:
SFI-RNTI: identification of slot format;
TPC-PUCCH-RNTI: unique UE identification to control the power of PUCCH;
TPC-PUSCH-RNTI: unique UE identification to control the power of PUSCH;
TPC-SRS-RNTI: unique UE identification to control the power of SRS;
   During the random access procedure, the following identities are also used:
RA-RNTI: identification of the Random Access Response in the downlink;
Temporary C-RNTI: UE identification temporarily used for scheduling during the random access procedure;
Random value for contention resolution: UE identification temporarily used for contention resolution purposes during the random access procedure.
   For NR connected to 5GC, the following UE identities are used at NG-RAN level:
I-RNTI: used to identify the UE context in RRC_INACTIVE.

The size of various fields in the time domain is expressed in time units T_{c}=1/(Δƒₘₐₓ ×N_{f}) where Δƒₘₐₓ=480×10³ Hz and N_{f}=4096. The constant κ=Tₛ/T_{c}=64 where Tₛ=1/(Δƒ_{ref}·N_{f,ref}) Δƒ_{ref}=15·10³ Hz and N_{f,ref}=2048.

Multiple OFDM numerologies are supported as given by Table 4.2-1 of [TS 38.211] where μ and the cyclic prefix for a bandwidth part are obtained from the higher-layer parameter subcarrierSpacing and cyclicPrefix, respectively.

The size of various fields in the time domain may be expressed as a number of time units T_{c}=1/(15000×2048) seconds. Downlink and uplink transmissions are organized into frames with T_{ƒ}=(ΔƒₘₐₓN_{ƒ}/100)·T_{c}=10 ms duration, each consisting of ten subframes of T_{sƒ}=(ΔƒₘₐₓN_{ƒ}/1000)·T_{c}=1 ms duration. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

For subcarrier spacing (SCS) configuration μ, slots are numbered nₛ^{μ}∈{0, . . . , Nₛₗₒₜ^{subframe,μ}−1} in increasing order within a subframe and n_{s,ƒ}^{μ}∈{0, . . . , Nₛₗₒₜ^{frame,μ}−1} in increasing order within a frame. Nₛₗₒₜ^{subframe,μ} is the number of slots per subframe for subcarrier spacing configuration μ. There are N_{symb}^{slot} consecutive OFDM symbols in a slot where N_{symb}^{slot} depends on the cyclic prefix as given by Tables 4.3.2-1 and 4.3.2-2 of [TS 38.211]. The start of slot nₛ^{μ} in a subframe is aligned in time with the start of OFDM symbol nₛ^{μ}N_{symb}^{slot} in the same subframe. Subcarrier spacing refers to a spacing (or frequency bandwidth) between two consecutive subcarriers in the frequency domain. For example, the subcarrier spacing can be set to 15 kHz (i.e. μ=0), 30 kHz (i.e. μ=1), 60 kHz (i.e. μ=2), 120 kHz (i.e. μ=3), or 240 kHz (i.e. μ=4). A resource block is defined as a number of consecutive subcarriers (e.g. 12) in the frequency domain. For a carrier with different frequency, the applicable subcarrier may be different. For example, for a carrier in a frequency rang 1, a subcarrier spacing only among a set of {15 kHz, 30 kHz, 60 kHz} is applicable. For a carrier in a frequency rang 2, a subcarrier spacing only among a set of {60 kHz, 120 kHz, 240 KHz} is applicable. The base station may not configure an inapplicable subcarrier spacing for a carrier.

OFDM symbols in a slot can be classified as ‘downlink’, ‘flexible’, or ‘uplink’. Signaling of slot formats is described in subclause 11.1 of [TS 38.213].

In a slot in a downlink frame, the UE may assume that downlink transmissions only occur in ‘downlink’ or ‘flexible’ symbols. In a slot in an uplink frame, the UE may only transmit in ‘uplink’ or ‘flexible’ symbols.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

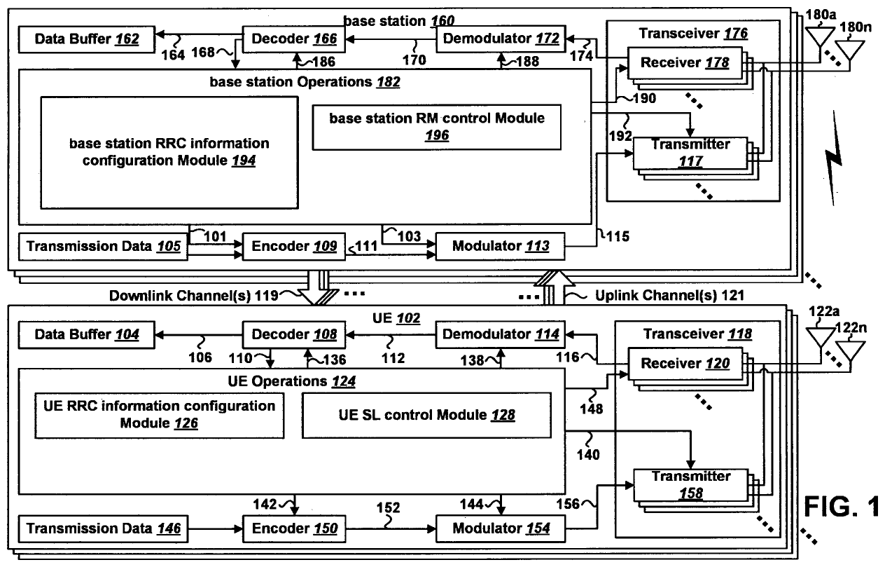

FIG. 1 is a block diagram illustrating one configuration of one or more base stations 160 (e.g., eNB, gNB) and one or more user equipments (UEs) 102 in which systems and methods for interlaced PSFCH transmission may be implemented. The one or more UEs 102 may communicate with one or more base stations 160 using one or more antennas 122a-n. For example, a UE 102 transmits electromagnetic signals to the base station 160 and receives electromagnetic signals from the base station 160 using the one or more antennas 122a-n. The base station 160 communicates with the UE 102 using one or more antennas 180a-n. Additionally, one or more UEs 102 may communicate with one or more UEs 102 using one or more antennas 122a-n. For example, a UE 102 transmits electromagnetic signals to another UE(s) 102 and receives electromagnetic signals from another UE(s) 102 using the one or more antennas 122a-n. That is, one or more UEs communicate with each other via sidelink communication.

The UEs 102 may directly communicate with each other by using the sidelink communication. For illustration, UE(s) 102 capable of sidelink communication includes a UE 1A, a UE 1B and a UE 1C. The UE 1A may be located within the coverage of the base station 160. The UE 1B and the UE 1C may be located outside the coverage of the base station 160. The UE 1A and the UE 1B may directly communicate with each other via sidelink communication. In addition, the UE 1B and the UE 1C may directly communicate with each other via sidelink communication.

It should be noted that in some configurations, one or more of the UEs 102 described herein may be implemented in a single device. For example, multiple UEs 102 may be combined into a single device in some implementations. Additionally or alternatively, in some configurations, one or more of the base stations 160 described herein may be implemented in a single device. For example, multiple base stations 160 may be combined into a single device in some implementations. In the context of FIG. 1, for instance, a single device may include one or more UEs 102 in accordance with the systems and methods described herein. Additionally or alternatively, one or more base stations 160 in accordance with the systems and methods described herein may be implemented as a single device or multiple devices.

The UE 102 and the base station 160 may use one or more channels 119, 121 to communicate with each other. For example, a UE 102 may transmit information or data to the base station 160 using one or more uplink (UL) channels 121 and signals. Examples of uplink channels 121 include a physical uplink control channel (PUCCH) and a physical uplink shared channel (PUSCH), etc. Examples of uplink signals include a demodulation reference signal (DMRS) and a sounding reference signal (SRS), etc. The one or more base stations 160 may also transmit information or data to the one or more UEs 102 using one or more downlink (DL) channels 119 and signals, for instance. Examples of downlink channels 119 include a PDCCH, a PDSCH, etc. A PDCCH can be used to schedule DL transmissions on PDSCH and UL transmissions on PUSCH, where the Downlink Control Information (DCI) on PDCCH includes downlink assignment and uplink scheduling grants. The PDCCH is used for transmitting Downlink Control Information (DCI) in a case of downlink radio communication (radio communication from the base station to the UE). Here, one or more DCIs (may be referred to as DCI formats) are defined for transmission of downlink control information. Information bits are mapped to one or more fields defined in a DCI format. Examples of downlink signals include a primary synchronization signal (PSS), a secondary synchronization signal (SSS), a cell-specific reference signal (CRS), a non-zero power channel state information reference signal (NZP CSI-RS), and a zero power channel state information reference signal (ZP CSI-RS), etc. Other kinds of channels or signals may be used.

For the UE(s) 102 capable of sidelink communication, the UEs 102 may use one or more sidelink channels to communicate with each other. For example, a UE 102 may transmit information or data to another UE 102 using one or more sidelink (SL) channels 121 and signals.

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals (e.g., downlink channels, downlink signals, sidelink channels, sidelink signals) from the base station 160 or from another UE 102 using one or more antennas 122a-n. For example, the receiver 120 may receive and downconvert signals to produce one or more received signals 116. The one or more received signals 116 may be provided to a demodulator 114. The one or more transmitters 158 may transmit signals (e.g., uplink channels, uplink signals, sidelink channels, sidelink signals) to the base station 160 or to another UE 102 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more base stations 160. For a UE capable of sidelink communication, the UE operations module 124 may enable the UE 102 to communicate with the one or more other UE. The UE operations module 124 may include a UE RRC information configuration module 126. For a UE capable of sidelink communication, the UE operations module 124 may include a UE sidelink (SL) control module 128. In some implementations, the UE operations module 124 may include physical (PHY) entities, Medium Access Control (MAC) entities, Radio Link Control (RLC) entities, packet data convergence protocol (PDCP) entities, and a Radio Resource Control (RRC) entity. For example, the UE RRC information configuration module 126 may process RRC parameter for random access configurations, initial UL BWP configuration, maximum bandwidth the UE can support, and cell specific PUCCH resource configuration(s).

For a UE capable of sidelink transmission, the UE RRC information configuration module 126 may process parameters included the (pre-)configuration(s) related to sidelink communications. For example, the UE RRC information configuration module 126 may process parameters to determine a SL BWPs, one or more resource pools within the SL BWP in frequency domain and time domain for SL communications. The UE SL control module 128 may determine the frequency resources and the time resources for transmission or reception of the PSCCH, the PSSCH and the PSFCH. The frequency resources for transmission or reception of the PSCCH, the PSSCH and the PSFCH include information related to assigned interlace(s) and RB set(s). The UE SL control module (processing module) 128 may determine a PSFCH resource carrying HARQ feedback information in response to PSSCH reception/transmission. The UE SL control module 128 may determine a PSFCH resource in frequency domain by using a first interlace index and/or a first RB set index.

The UE operations module 124 may provide information 148 to the one or more receivers 120. For example, the UE operations module 124 may inform the receiver(s) 120 when or when not to receive transmissions based on the Radio Resource Control (RRC) message (e.g., broadcasted system information, RRC reconfiguration message), MAC control element, and/or the DCI (Downlink Control Information). The UE operations module 124 may provide information 148, including the PDCCH monitoring occasions, DCI format size, PSCCH monitoring occasions and SCI format size, to the one or more receivers 120. The UE operation module 124 may inform the receiver(s) 120 when or where to receive/monitor the PDCCH candidate for DCI formats and/or the PSCCH candidate for SCI formats.

The UE operations module 124 may provide information 138 to the demodulator 114. For example, the UE operations module 124 may inform the demodulator 114 of a modulation pattern anticipated for transmissions from the base station 160.

The UE operations module 124 may provide information 136 to the decoder 108. For example, the UE operations module 124 may inform the decoder 108 of an anticipated encoding for transmissions from the base station 160. For example, the UE operations module 124 may inform the decoder 108 of an anticipated PDCCH candidate encoding with which DCI size for transmissions from the base station 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the base station 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the base station 160 or another. UE 102. The one or more transmitters 158 may upconvert and transmit the modulated signal(s) 156 to one or more base stations 160 or another one or more UEs 102.

The base station 160 may include one or more transceivers 176, one or more demodulators 172, one or more decoders 166, one or more encoders 109, one or more modulators 113, one or more data buffers 162 and one or more base station operations modules 182. For example, one or more reception and/or transmission paths may be implemented in a base station 160. For convenience, only a single transceiver 176, decoder 166, demodulator 172, encoder 109 and modulator 113 are illustrated in the base station 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals (e.g., uplink channels, uplink signals) from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals (e.g., downlink channels, downlink signals) to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The base station 160 may use the decoder 166 to decode signals. The decoder 166 may produce one or more decoded signals 164, 168. For example, a first base station-decoded signal 164 may comprise received payload data, which may be stored in a data buffer 162. A second base station-decoded signal 168 may comprise overhead data and/or control data. For example, the second base station-decoded signal 168 may provide data (e.g., PUSCH transmission data) that may be used by the base station operations module 182 to perform one or more operations.

In general, the base station operations module 182 may enable the base station 160 to communicate with the one or more UEs 102. The base station operations module 182 may include a base station RRC information configuration module 194. The base station operations module 182 may include a base station resource management (RM) control module 196 (or a base station RM processing module 196). The base station operations module 182 may include PHY entities, MAC entities, RLC entities, PDCP entities, and an RRC entity.

The base station RM control module 196 may determine, for respective UE, when and where to transmit the preamble, the time and frequency resource of PRACH occasions and input the information to the base station RRC information configuration module 194. The base station RM control module 196 may generate a DCI format to indicate frequency and time resources of PSSCH to a UE 102.

The base station operations module 182 may provide the benefit of performing PDCCH candidate search and monitoring efficiently. The base station operations module 182 may provide information 190 to the one or more receivers 178. For example, the base station operations module 182 may inform the receiver(s) 178 when or when not to receive transmissions based on the RRC message (e.g., broadcasted system information, RRC reconfiguration message), MAC control element, and/or the DCI (Downlink Control Information).

The base station operations module 182 may provide information 188 to the demodulator 172. For example, the base station operations module 182 may inform the demodulator 172 of a modulation pattern anticipated for transmissions from the UE(s) 102.

The base station operations module 182 may provide information 186 to the decoder 166. For example, the base station operations module 182 may inform the decoder 166 of an anticipated encoding for transmissions from the UE(s) 102.

The base station operations module 182 may provide information 101 to the encoder 109. The information 101 may include data to be encoded and/or instructions for encoding. For example, the base station operations module 182 may instruct the encoder 109 to encode transmission data 105 and/or other information 101.

In general, the base station operations module 182 may enable the base station 160 to communicate with one or more network nodes (e.g., a NG mobility management function, a NG core UP functions, a mobility management entity (MME), serving gateway (S-GW), gNBs). The base station operations module 182 may also generate a RRC reconfiguration message to be signaled to the UE 102.

The encoder 109 may encode transmission data 105 and/or other information 101 provided by the base station operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The base station operations module 182 may provide information 103 to the modulator 113. This information 103 may include instructions for the modulator 113. For example, the base station operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The base station operations module 182 may provide information 192 to the one or more transmitters 117. This information 192 may include instructions for the one or more transmitters 117. For example, the base station operations module 182 may instruct the one or more transmitters 117 when to (or when not to) transmit a signal to the UE(s) 102. The base station operations module 182 may provide information 192, including the PDCCH monitoring occasions and DCI format size, to the one or more transmitters 117. The base station operation module 182 may inform the transmitter(s) 117 when or where to transmit the PDCCH candidate for DCI formats with which DCI size. The one or more transmitters 117 may upconvert and transmit the modulated signal(s) 115 to one or more UEs 102.

It should be noted that one or more of the elements or parts thereof included in the base station(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

A base station may generate a RRC message including the one or more RRC parameters, and may transmit the RRC message to a UE. A UE may receive, from a base station, a RRC message including one or more RRC parameters. The term ‘RRC parameter(s)’ in the present disclosure may be alternatively referred to as ‘RRC information element(s)’. A RRC parameter may further include one or more RRC parameter(s). In the present disclosure, a RRC message may include system information. a RRC message may include one or more RRC parameters. A RRC message may be sent on a broadcast control channel (BCCH) logical channel, a common control channel (CCCH) logical channel or a dedicated control channel (DCCH) logical channel.

In the present disclosure, a description ‘a base station may configure a UE to’ may also imply/refer to ‘a base station may transmit, to a UE, an RRC message including one or more RRC parameters’. Additionally or alternatively, ‘RRC parameter configure a UE to’ may also refer to ‘a base station may transmit, to a UE, an RRC message including one or more RRC parameters’. Additionally or alternatively, ‘a UE is configured to’ may also refer to ‘a UE may receive, from a base station, an RRC message including one or more RRC parameters’.

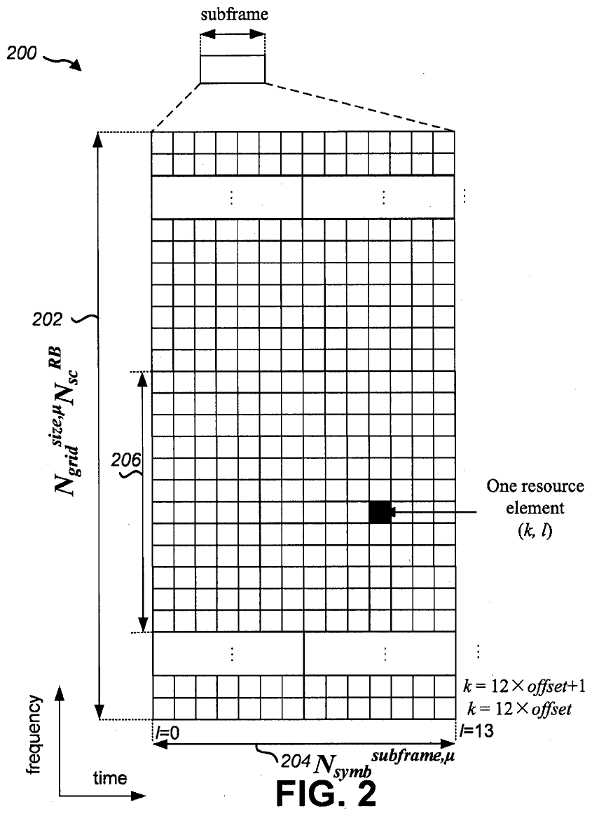

FIG. 2 is a diagram illustrating one example of a resource grid 200.

For each numerology and carrier, a resource grid of N_{grid,x}^{size,μ}N_{sc}^{RB} subcarriers and N_{symb}^{subframe,μ} OFDM symbols is defined, starting at common resource block N_{grid}^{start,μ} indicated by higher layer signaling. There is one set of resource grids per transmission direction (uplink or downlink) with the subscript x set to DL and UL for downlink and uplink, respectively. There is one resource grid for a given antenna port p, subcarrier spacing configuration μ, and the transmission direction (downlink or uplink). When there is no risk for confusion, the subscript x may be dropped.

In the FIG. 2, the resource gird 200 includes the N_{grid,x}^{size,μ}N_{sc}^{RB} (202) subcarriers in the frequency domain and includes N_{symb}^{subframe,μ} (204) symbols in the time domain. In the FIG. 2, as an example for illustration, the subcarrier spacing configuration μ is set to 0. That is, in the FIG. 2, the number of consecutive OFDM symbols N_{symb}^{subframe,μ} (204) per subframe is equal to 14.

The carrier bandwidth N_{grid}^{size,μ} (N_{grid,x}^{size,μ}) for subcarrier spacing configuration μ is given by the higher-layer (RRC) parameter carrierBandwidth in the SCS-SpecificCarrier IE. The starting position N_{grid}^{start,μ} for subcarrier spacing configuration μ is given by the higher-layer parameter offsetToCarrier in the SCS-SpecificCarrier IE. The frequency location of a subcarrier refers to the center frequency of that subcarrier.

In the FIG. 2, for example, a value of offset is provided by the higher-layer parameter offsetToCarrier. That is, k=12×offset is the lowest usable subcarrier on this carrier.

Each element in the resource grid for antenna port p and subcarrier spacing configuration μ is called a resource element and is uniquely identified by (k, l)_{p,μ} where k is the index in the frequency domain and l refers to the symbols position in the time domain relative to same reference point. The resource element consists of one subcarrier during one OFDM symbol.

A resource block is defined as N_{sc}^{RB}=12 consecutive subcarriers in the frequency domain. As shown in the FIG. 2, a resource block 206 includes 12 consecutive subcarriers in the frequency domain. Resource block can be classified as common resource block (CRB) and physical resource block (PRB).

Common resource blocks are numbered from 0 and upwards in the frequency domain for subcarrier spacing configuration μ. The center of subcarrier 0 of common resource block with index 0 (i.e. CRB0) for subcarrier spacing configuration μ coincides with point A. The relation between the common resource block number n_{CRB}^{μ} in the frequency domain and resource element (k, l) for subcarrier spacing configuration μ is given by Formula (1) n_{CRB}^{μ}=floor(k/N_{sc}^{RB}) where k is defined relative to the point A such that k=0 corresponds to the subcarrier centered around the point A. The function floor (A) hereinafter is to output a maximum integer not larger than the A.

Point A refers to as a common reference point. Point A coincides with subcarrier 0 (i.e., k=0) of a CRB 0 for all subcarrier spacing. Point A can be obtained from a RRC parameter offsetToPointA or a RRC parameter absoluteFrequencyPointA. The RRC parameter offsetToPointA is used for a PCell downlink and represents the frequency offset between point A and the lowest subcarrier of the lowest resource block, which has the subcarrier spacing provided by a higher-layer parameter subCarrierSpacingCommon and overlaps with the SS/PBCH block used by the UE for initial cell selection, expressed in units of resource blocks assuming 15 kHz subcarrier spacing for frequency range (FR) 1 and 60 kHz subcarrier spacing for frequency range (FR2). FR1 corresponds to a frequency range between 410 MHz and 7125 MHz. FR2 corresponds to a frequency range between 24250 MHz and 52600 MHz. The RRC parameter absoluteFrequencyPointA is used for all cased other than the PCell case and represents the frequency-location of point A expressed as in ARFCN. The frequency location of point A can be the lowest subcarrier of the carrier bandwidth (or the actual carrier). Additionally, point A may be located outside the carrier bandwidth (or the actual carrier).

As above mentioned, the information element (IE) SCS-SpecificCarrier provides parameters determining the location and width of the carrier bandwidth or the actual carrier. That is, a carrier (or a carrier bandwidth, or an actual carrier) is determined (identified, or defined) at least by a RRC parameter offsetToCarrier, a RRC parameter subcarrierSpacing, and a RRC parameter carrierBandwidth in the SCS-SpecificCarrier IE.

The subcarrierSpacing indicates (or defines) a subcarrier spacing of the carrier. The offsetToCarrier indicates an offset in frequency domain between point A and a lowest usable subcarrier on this carrier in number of resource blocks (e.g. CRBs) using the subcarrier spacing defined for the carrier. The carrierBandwidth indicates width of this carrier in number of resource blocks (e.g. CRBs or PRBs) using the subcarrier spacing defined for the carrier. A carrier includes at most 275 resource blocks.

Physical resource block for subcarrier spacing configuration μ are defined within a bandwidth part and numbered form 0 to N_{BWP,i}^{size,μ} where i is the number of the bandwidth part. The relation between the physical resource block n_{PRB}^{μ} in bandwidth part (BWP) i and the common resource block n_{CRB}^{μ} is given by Formula (2) n_{CRB}^{μ}=N_{PRB}^{μ}+N_{BWP,i}^{start,μ} where N_{BWP,i}^{start,μ} is the common resource block where bandwidth part i starts relative to common resource block 0 (CRB0). When there is no risk for confusion the index μ may be dropped.

A BWP is a subset of contiguous common resource block for a given subcarrier spacing configuration μ on a given carrier. To be specific, a BWP can be identified (or defined) at least by a subcarrier spacing μ indicated by the RRC parameter subcarrierSpacing, a cyclic prefix determined by the RRC parameter cyclicPrefix, a frequency domain location, a bandwidth, an BWP index indicated by bwp-Id and so on. The locationAndBandwidth can be used to indicate the frequency domain location and bandwidth of a BWP. The value indicated by the locationAndBandwidth is interpreted as resource indicator value (RIV) corresponding to an offset (a starting resource block) RBₛₜₐᵣₜ and a length L_{RB} in terms of contiguously resource blocks. The offset RBₛₜₐᵣₜ is a number of CRBs between the lowest CRB of the carrier and the lowest CRB of the BWP. The N_{BWP,i}^{start,μ} is given as Formula (3) N_{BWP,i}^{start,μ}=O_{carrier}+RBₛₜₐᵣₜ. The value of O_{carrier} is provided by offsetTocarrier for the corresponding subcarrier spacing configuration μ.

A UE 102 configured to operate in BWPs of a serving cell, is configured by higher layers for the serving cell a set of at most four BWPs in the downlink for reception. At a given time, a single downlink BWP is active. The bases station 160 may not transmit, to the UE 102, PDSCH and/or PDCCH outside the active downlink BWP. A UE 102 configured to operate in BWPs of a serving cell, is configured by higher layers for the serving cell a set of at most four BWPs for transmission. At a given time, a single uplink BWP is active. The UE 102 may not transmit, to the base station 160, PUSCH or PUCCH outside the active BWP. The specific signaling (higher layers signaling) for BWP configurations are described later.

A UE 102, configured to operate in a SL BWP, is configured or pre-configured by higher layers for the serving cell or by a pre-configuration a SL BWP for sidelink reception and/or transmission. At a given time, a single SL BWP is active. The UE 102 may not transmit, to another UE 102, sidelink channel (PSCCH, PSCCH, and/or PSFCH) outside the active SL BWP.

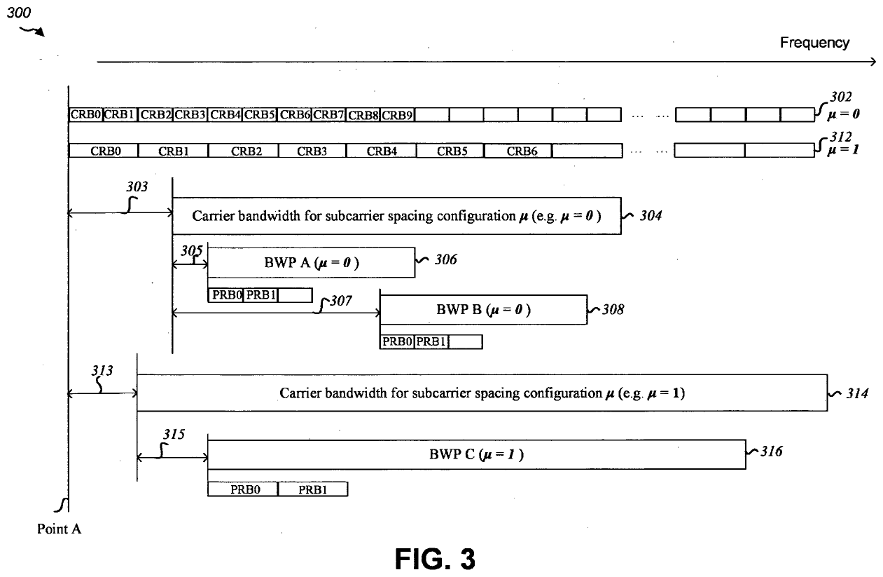

FIG. 3 is a diagram illustrating one example 300 of common resource block grid, carrier configuration and BWP configuration by a UE 102 and a base station 160.

Point A 301 is a lowest subcarrier of a CRB0 for all subcarrier spacing configurations. The CRB grid 302 and the CRB grid 312 are corresponding to two different subcarrier spacing configurations. The CRB grid 302 is for subcarrier spacing configuration μ=0 (i.e. the subcarrier spacing with 15 kHz). The CRB grid 312 is for subcarrier spacing configuration μ=1 (i.e., the subcarrier spacing with 30 kHz).

One or more carriers are determined by respective SCS-SpecificCarrier IEs, respectively. In the FIG. 3, the carrier 304 uses the subcarrier spacing configuration μ=0. And the carrier 314 uses the subcarrier spacing configuration μ=1. The starting position N_{grid}^{start,μ} of the carrier 304 is given based on the value of an offset 303 (i.e. O_{carrier}) indicated by an offsetToCarrier in an SCS-SpecificCarrier IE. As shown in the FIG. 3, for example, the offsetToCarrier indicates the value of the offset 303 as O_{carrier}=3. That is, the starting position N_{grid}^{start,μ} of the carrier 304 corresponds to the CRB3 of the CRB grid 302 for subcarrier spacing configuration μ=0. In the meantime, the starting position N_{grid}^{start,μ} of the carrier 314 is given based on the value of an offset 313 (i.e. O_{carrier}) indicated by an offsetToCarrier in another SCS-SpecificCarrier IE. For example, the offsetToCarrier indicates the value of the offset 313 as O_{carrier}=1. That is, the starting position N_{grid}^{start,μ} of the carrier 314 corresponds to the CRB1 of the CRB grid 312 for subcarrier spacing configuration μ=1. A carrier using different subcarrier spacing configurations can occupy different frequency ranges.

As above-mentioned, a BWP is for a given subcarrier spacing configuration μ. One or more BWPs can be configured for a same subcarrier spacing configuration μ. For example, in the FIG. 3, the BWP 306 is identified at least by the μ=0, a frequency domain location, a bandwidth (L_{RB}), and an BWP index (index A). The first PRB (i.e. PRB0) of a BWP is determined at least by the subcarrier spacing of the BWP, an offset derived by the locationAndBandwidth and an offset indicated by the offsetToCarrier corresponding to the subcarrier spacing of the BWP. An offset 305 (RBₛₜₐᵣₜ) is derived as 1 by the locationAndBandwidth. According to the Formulas (2) and (3), the PRB0 of BWP 306 corresponds to CRB 4 of the CRB grid 302, and the PRB1 of BWP 306 corresponds to CRB 5 of the CRB grid 302, and so on.

Additionally, in the FIG. 3, the BWP 308 is identified at least by the μ=0, a frequency domain location, a bandwidth (L_{RB}), and an BWP index (index B). For example, an offset 307 (RBₛₜₐᵣₜ) is derived as 6 by the locationAndBandwidth. According to the Formulas (2) and (3), the PRB0 of BWP 308 corresponds to CRB 9 of the CRB grid 302, and the PRB1 of BWP 308 corresponds to CRB 10 of the CRB grid 302, and so on.

Additionally, in the FIG. 3, the BWP 316 is identified at least by the μ=1, a frequency domain location, a bandwidth (L_{RB}), and an BWP index (index C). For example, an offset 315 (RBₛₜₐᵣₜ) is derived as 1 by the locationAndBandwidth. According to the Formulas (2) and (3), the PRB0 of BWP 316 corresponds to CRB 2 of the CRB grid 312, and the PRB1 of BWP 316 corresponds to CRB 3 of the CRB grid 312, and so on.

A BWP illustrated in the FIG. 3 may refer to a DL BWP, a UL BWP, or a sidelink BWP.

As shown in the FIG. 3, a carrier with the defined subcarrier spacing locate in a corresponding CRB grid with the same subcarrier spacing. A BWP with the defined subcarrier spacing locate in a corresponding CRB grid with the same subcarrier spacing as well.

A base station may transmit a RRC message including one or more RRC parameters related to BWP configuration to a UE. A UE may receive the RRC message including one or more RRC parameters related to BWP configuration from a base station. For each cell, the base station may configure at least an initial DL BWP, one initial uplink bandwidth parts (initial UL BWP) and one sidelink BWP to the UE. Furthermore, the base station may configure additional UL and DL BWPs to the UE for a cell.

A RRC parameters initialDownlinkBWP may indicate the initial downlink BWP (initial DL BWP) configuration for a serving cell (e.g., a SpCell and Scell). The base station may configure the RRC parameter locationAndBandwidth included in the initialDownlinkBWP so that the initial DL BWP contains the entire CORESET 0 of this serving cell in the frequency domain. The locationAndBandwidth may be used to indicate the frequency domain location and bandwidth of a BWP. A RRC parameters initialUplinkBWP may indicate the initial uplink BWP (initial UL BWP) configuration for a serving cell (e.g., a SpCell and Scell). The base station may transmit initialDownlinkBWP and/or initialUplinkBWP which may be included in SIB1, RRC parameter ServingCellConfigCommon, or RRC parameter ServingCellConfig to the UE.

The initialDownlinkBWP may include one, more or all of (I) generic parameters (e.g. locationAndBandwidth, subcarrierSpacing, cyclicPrefix) of the initial Downlink BWP, (II) cell specific parameters (e.g. pdcch-ConfigCommon) for PDCCH of the initial downlink BWP, (III) cell specific parameters (e.g. pdsch-ConfigCommon) for the PDSCH of the initial downlink BWP. The initialUplinkBWP may include one, more or all of (I) generic parameters (e.g. locationAndBandwidth, subcarrierSpacing, cyclicPrefix) of the initial UL BWP, (II) cell specific parameters (e.g. pucch-ConfigCommon) for PUCCH of the initial UL BWP, (III) cell specific parameters (e.g. pusch-ConfigCommon) for the PUSCH of the initial UL BWP, and (IV) cell specific random access parameters (e.g. rach-ConfigCommon).

SIB1, which is a cell-specific system information block (SystemInformationBlock, SIB), may contain information relevant when evaluating if a UE is allowed to access a cell and define the scheduling of other system information. SIB1 may also contain radio resource configuration information that is common for all UEs and barring information applied to the unified access control. The RRC parameter ServingCellConfigCommon is used to configure cell specific parameters of a UE's serving cell. The RRC parameter ServingCellConfig is used to configure (add or modify) the UE with a serving cell, which may be the SpCell or an SCell of an MCS or SCG. The RRC parameter ServingCellConfig herein are mostly UE specific but partly also cell specific.

The base station may configure the UE with a RRC parameter BWP-Downlink and a RRC parameter BWP-Uplink. The RRC parameter BWP-Downlink can be used to configure an additional DL BWP. The RRC parameter BWP-Uplink can be used to configure an additional UL BWP. The base station may transmit the BWP-Downlink and the BWP-Uplink which may be included in RRC parameter ServingCellConfig to the UE.

If a UE is not configured (provided) initialDownlinkBWP from a base station, an initial DL BWP is defined by a location and number of contiguous physical resource blocks (PRBs), starting from a PRB with the lowest index and ending at a PRB with the highest index among PRBs of a CORESET for Type0-PDCCH CSS set (i.e. CORESET 0), and a subcarrier spacing (SCS) and a cyclic prefix for PDCCH reception in the CORESET for Type0-PDCCH CSS set. If a UE is configured (provided) initialDownlinkBWP from a base station, the initial DL BWP is provided by initialDownlinkBWP. If a UE is configured (provided) initialUplinkBWP from a base station, the initial UL BWP is provided by initialUplinkBWP.

The UE may be configured by the based station, at least one initial BWP and up to 4 additional BWP(s). One of the initial BWP and the configured additional BWP(s) may be activated as an active BWP. The UE may monitor DCI format, and/or receive PDSCH in the active DL BWP. The UE may not monitor DCI format, and/or receive PDSCH in a DL BWP other than the active DL BWP. The UE may transmit PUSCH and/or PUCCH in the active UL BWP. The UE may not transmit PUSCH and/or PUCCH in a BWP other than the active UL BWP.

As above-mentioned, a UE may monitor DCI format in the active DL BWP. To be more specific, a UE may monitor a set of PDCCH candidates in one or more CORESETs on the active DL BWP on each activated serving cell configured with PDCCH monitoring according to corresponding search space set where monitoring implies decoding each PDCCH candidate according to the monitored DCI formats.

A set of PDCCH candidates for a UE to monitor is defined in terms of PDCCH search space sets. A search space set can be a CSS set or a USS set. A UE may monitor a set of PDCCH candidates in one or more of the search space sets.

For a DL BWP, if a UE is configured (provided) one above-described search space set, the UE may determine PDCCH monitoring occasions for a set of PDCCH candidates of the configured search space set. PDCCH monitoring occasions for monitoring PDCCH candidates of a search space set s is determined according to the search space set s configuration and a CORESET configuration associated with the search space set s. In other words, a UE may monitor a set of PDCCH candidates of the search space set in the determined (configured) PDCCH monitoring occasions in one or more configured control resource sets (CORESETs) according to the corresponding search space set configurations and CORESET configuration. A base station may transmit, to a UE, information to specify one or more CORESET configuration and/or search space configuration. The information may be included in MIB and/or SIBs broadcasted by the base station. The information may be included in RRC configurations or RRC parameters. A base station may broadcast system information such as MIB, SIBs to indicate CORESET configuration or search space configuration to a UE. Or the base station may transmit a RRC message including one or more RRC parameters related to CORESET configuration and/or search space configuration to a UE.

An illustration of search space set configuration is described below.

A base station may transmit a RRC message including one or more RRC parameters related to search space configuration. A base station may determine one or more RRC parameter(s) related to search space configuration for a UE. A UE may receive, from a base station, a RRC message including one or more RRC parameters related to search space configuration. RRC parameter(s) related to search space configuration (e.g. SearchSpace, searchSpaceZero) defines how and where to search for PDCCH candidates. ‘search/monitor for PDCCH candidate for a DCI format’ may also refer to ‘monitor/search for a DCI format’ for short.

For example, a RRC parameter searchSpaceZero is used to configure a common search space 0 of an initial DL BWP. The searchSpaceZero corresponds to 4 bits. The base station may transmit the searchSpaceZero via PBCH (MIB) or ServingCell.

Additionally, a RRC parameter SearchSpace is used to define how/where to search for PDCCH candidates. The RRC parameters search space may include a plurality of RRC parameters as like, searchSpaceld, controlResourceSetId, monitoringSlotPeriodicityAndOffset, duration, monitoringSymbolsWithinSlot, nrofCandidates, searchSpaceType. Some of the above-mentioned RRC parameters may be present or absent in the RRC parameters SearchSpace. Namely, the RRC parameter SearchSpace may include all the above-mentioned RRC parameters. Namely, the RRC parameter SearchSpace may include one or more of the above-mentioned RRC parameters. If some of the parameters are absent in the RRC parameter SearchSpace, the UE 102 may apply a default value for each of those parameters.

Herein, the RRC parameter searchSpaceId is an identity or an index of a search space. The RRC parameter searchSpaceId is used to identify a search space. Or rather, the RRC parameter serchSpaceId provide a search space set index s, 0<=s<40. Then a search space s hereinafter may refer to a search space identified by index s indicated by RRC parameter searchSpaceId. The RRC parameter controlResourceSetId concerns an identity of a CORESET, used to identify a CORESET. The RRC parameter controlResourceSetId indicates an association between the search space s and the CORESET identified by controlResourceSetId. The RRC parameter controlResourceSetId indicates a CORESET applicable for the search space. CORESET p hereinafter may refer to a CORESET identified by index p indicated by RRC parameter controlResourceSetId. Each search space is associated with one CORESET. The RRC parameter monitoringSlotPeriodicityAndOffset is used to indicate slots for PDCCH monitoring configured as periodicity and offset. Specifically, the RRC parameter monitoringSlotPeriodicityAndOffset indicates a PDCCH monitoring periodicity of kₛ slots and a PDCCH monitoring offset of oₛ slots. A UE can determine which slot is configured for PDCCH monitoring according to the RRC parameter monitoringSlotPeriodicityAndOffset. The RRC parameter monitoringSymbolsWithinSlot is used to indicate a first symbol(s) for PDCCH monitoring in the slots configured for PDCCH monitoring. That is, the parameter monitoringSymbolsWithinSlot provides a PDCCH monitoring pattern within a slot, indicating first symbol(s) of the CORESET within a slot (configured slot) for PDCCH monitoring. The RRC parameter duration indicates a number of consecutive slots Tₛ that the search space lasts (or exists) in every occasion (PDCCH occasion, PDCCH monitoring occasion).

The RRC parameter may include aggregationLevel1, aggregationLevel2, aggregationLevel4, aggregationLevel8, aggregationLevel16. The RRC parameter nrofCandidates may provide a number of PDCCH candidates per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, for CCE aggregation level 8, and CCE aggregation level 16, respectively. In other words, the value L can be set to either one in the set {1, 2, 4, 8,16}. The number of PDCCH candidates per CCE aggregation level L can be configured as 0, 1, 2, 3, 4, 5, 6, or 8. For example, in a case the number of PDCCH candidates per CCE aggregation level L is configured as 0, the UE may not search for PDCCH candidates for CCE aggregation L. That is, in this case, the UE may not monitor PDCCH candidates for CCE aggregation L of a search space set s. For example, the number of PDCCH candidates per CCE aggregation level L is configured as 4, the UE may monitor 4 PDCCH candidates for CCE aggregation level L of a search space set s.

The RRC parameter searchSpaceType is used to indicate that the search space set s is either a CSS set or a USS set. The RRC parameter searchSpaceType may include either a common or a ue-Specific. The RRC parameter common configure the search space set s as a CSS set and DCI format to monitor. The RRC parameter ue-Specific configures the search space set s as a USS set. The RRC parameter ue-Specific may include dci-Formats. The RRC parameter dci-Formats indicates to monitor PDCCH candidates either for DCI format 0_0 and DCI format 1_0, or for DCI format 0_1 and DCI format 1_1 in search space set s. That is, the RRC parameter searchSpaceType indicates whether the search space set s is a CSS set or a USS set as well as DCI formats to monitor for. The RRC parameter ue-Specific may further include a new RRC parameter (e.g. dci-FormatsExt) in addition to the dci-Formats. The RRC parameter dci-FormatsExt indicates to monitor PDCCH candidates for DCI format 0_2 and DCI format 1_2, or for DCI format 0_1, DCI format 1_1, DCI format 0_2 and DCI format 1_2. If the RRC parameter dci-FormatsExt is included in the RRC parameter ue-Specific, the UE may ignore the RRC parameter dci-Formats. That is to say, the UE may not monitor the PDCCH candidates for DCI formats indicated by the RRC parameter dci-Format, and may monitor the PDCCH candidates for DCI formats indicated by the RRC parameter dci-FormatsExt.

The UE 102 may monitor PDCCH candidates for DCI format 0_0 and/or DCI format 1_0 in either a CSS or a USS. The UE 102 may monitor PDCCH candidates for DCI format 0_1, DCI format 1_1, DCI format 0_2 and/or DCI format 1_2 only in a USS but cannot monitor PDCCH candidates for DCI format 0_1, DCI format 1_1, DCI format 0_2, and/or DCI format 1_2 in a CSS. The DCI format 0_1 may schedule up to two transport blocks for one PUSCH while the DCI format 0_2 may only schedule one transport blocks for one PUSCH. DCI format 0_2 may not consist of some fields (e.g. ‘CBG transmission information’ field), which may be present in DCI format 0_1. Similarly, the DCI format 1_1 may schedule up to two transport blocks for one PDSCH while the DCI format 1_2 may only schedule one transport blocks for one PDSCH. DCI format 1_2 may not consist of some fields (e.g., ‘CBG transmission information’ field), which may be present in DCI format 1_1. The DCI format 1_2 and DCI format 1_1 may consist of one or more same DCI fields (e.g., ‘antenna port’ field).

The base station 160 may schedule a UE 102 to receive PDSCH by a downlink control information (DCI). A DCI format provides DCI and includes one or more DCI fields. The one or more DCI fields in a DCI format are mapped to the information bits. As above-mentioned, the UE 102 can be configured by the base station 160 one or more search space sets to monitor PDCCH for detecting corresponding DCI formats. If the UE 102 detects a DCI format (e.g., the DCI format 1_0, the DCI format 1_1, or the DCI format 1_2) in a PDCCH, the UE 102 may be scheduled by the DCI format to receive a PDSCH.

A USS at CCE aggregation level L is defined by a set of PDCCH candidates for CCE aggregation L. A USS set may be constructed by a plurality of USS corresponding to respective CCE aggregation level L. A USS set may include one or more USS(s) corresponding to respective CCE aggregation level L. A CSS at CCE aggregation level L is defined by a set of PDCCH candidates for CCE aggregation L. A CSS set may be constructed by a plurality of USS corresponding to respective CCE aggregation level L. A CSS set may include one or more CSS(s) corresponding to respective CCE aggregation level L.

Herein, ‘a UE monitor PDCCH for a search space set s’ also refers to ‘a UE may monitor a set of PDCCH candidates of the search space set s’. Alternatively, ‘a UE monitor PDCCH for a search space set s’ also refers to ‘a UE may attempt to decode each PDCCH candidate of the search space set s according to the monitored DCI formats’. As above-mentioned, the PDCCH is used for transmitting or carrying Downlink Control Information (DCI). Thus, ‘PDCCH’, ‘DCI’, ‘DCI format’, and/or ‘PDCCH candidate’ are virtually interchangeable. In other words, ‘a UE monitors PDCCH’ implies ‘a UE monitors PDCCH for a DCI format’. That is, ‘a UE monitors PDCCH’ implies ‘a UE monitors PDCCH for detection of a configured DCI format’.

In the present disclosure, the term “PDCCH search space sets” may also refer to “PDCCH search space”. A UE monitors PDCCH candidates in one or more of search space sets. A search space sets can be a common search space (CSS) set or a UE-specific search space (USS) set. In some implementations, a CSS set may be shared/configured among multiple UEs. The multiple UEs may search PDCCH candidates in the CSS set. In some implementations, a USS set is configured for a specific UE. The UE may search one or more PDCCH candidates in the USS set. In some implementations, a USS set may be at least derived from a value of C-RNTI addressed to a UE.

An illustration of CORESET configuration is described below.

A base station may configure a UE one or more CORESETs for each DL BWP in a serving cell. For example, a RRC parameter ControlResourceSetZero is used to configure CORESET 0 of an initial DL BWP. The RRC parameter ControlResourceSetZero corresponds to 4 bits. The base station may transmit ControlResourceSetZero, which may be included in MIB or RRC parameter ServingCellConfigCommon, to the UE. MIB may include the system information transmitted on BCH (PBCH). A RRC parameter related to initial DL BWP configuration may also include the RRC parameter ControlResourceSetZero. RRC parameter ServingCellConfigCommon is used to configure cell specific parameters of a UE's serving cell and contains parameters which a UE would typically acquire from SSB, MIB or SIBs when accessing the cell form IDLE.

Additionally, a RRC parameter ControlResourceSet is used to configure a time and frequency CORESET other than CORESET 0. The RRC parameter ControlResourceSet may include a plurality of RRC parameters such as, ControlResourceSetId, frequencyDomainResource, duration, cce-REG-MappingType, precoderGranularity, tci-PresentInDCI, pdcch-DMRS-ScramblingID and so on.

Here, the RRC parameter ControlResourceSetId is an CORESET index p, used to identify a CORESET within a serving cell, where 0<p<12. The RRC parameter duration indicates a number of consecutive symbols of the CORESET N_{symb}^{CORESET}, which can be configured as 1, 2 or 3 symbols. A CORESET consists of a set of N_{RB}^{CORESET} resource blocks (RBs) in the frequency domain and N_{symb}^{CORESET} symbols in the time domain. The RRC parameter frequencyDomainResource indicates the set of N_{RB}^{CORESET} RBs for the CORESET. Each bit in the frequencyDomainResource corresponds a group of 6 RBs, with grouping starting from the first RB group in the BWP. The first (left-most/most significant) bit corresponds to the first RB group in the BWP, and so on. The first common RB of the first RB group has common RB index 6×ceiling (N_{BWP}^{start}/6). A bit that is set to 1 indicates that this RB group belongs to the frequency domain resource of this CORESET. Bits corresponding to a group of RBs not fully contained in the bandwidth part within which the CORESET is configured are set to zero. The ceiling(A) function hereinafter is to output a smallest integer not less than A.

According to the CORESET configuration, a CORESET (a CORESET 0 or a CORESET p) consists of a set of PRBs with a time duration of 1 to 3 OFDM symbols. The resource units Resource Element Groups (REGs) and Control Channel Elements (CCEs) are defined within a CORESET. A CCE consists of 6 REGs where a REG equals one resource block during one OFDM symbol. Control channels are formed by aggregation of CCE. That is, a PDCCH consists of one or more CCEs. Different code rates for the control channels are realized by aggregating different number of CCE. Interleaved and non-interleaved CCE-to-REG mapping are supported in a CORESET. Each resource element group carrying PDCCH carries its own DMRS.

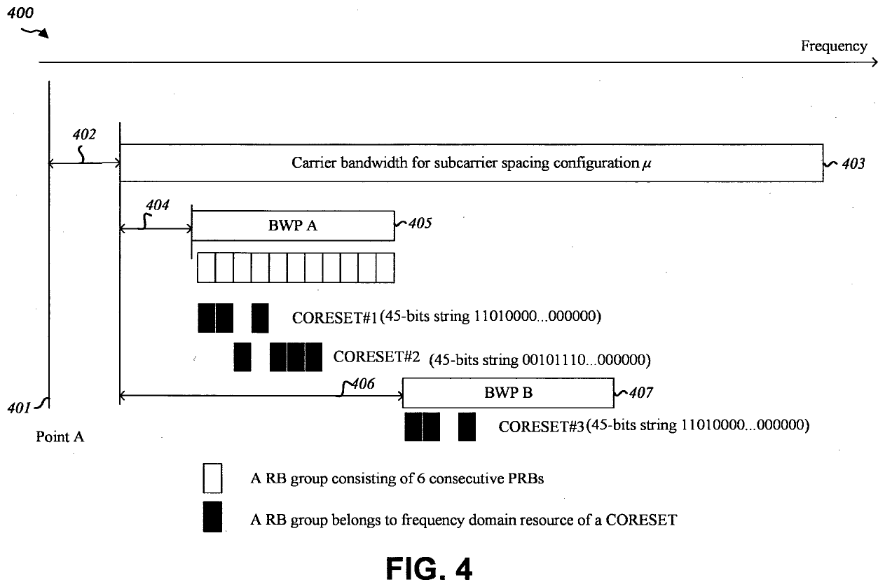

FIG. 4 is a diagram illustrating one 400 example of CORESET configuration in a BWP by a UE 102 and a base station 160.

FIG. 4 illustrates that a UE 102 is configured with three CORESETs for receiving PDCCH transmission in two BWPs. In the FIG. 4, 401 represent point A. 402 is an offset in frequency domain between point A 401 and a lowest usable subcarrier on the carrier 403 in number of CRBs, and the offset 402 is given by the offsetToCarrier in the SCS-SpecificCarrier IE. The BWP 405 with index A and the carrier 403 are for a same subcarrier spacing configuration μ. The offset 404 between the lowest CRB of the carrier and the lowest CRB of the BWP in number of RBs is given by the locationAndBandwidth included in the BWP configuration for BWP A. The BWP 407 with index B and the carrier 403 are for a same subcarrier spacing configuration μ. The offset 406 between the lowest CRB of the carrier and the lowest CRB of the BWP in number of RBs is given by the locationAndBandwidth included in the BWP configuration for BWP B.

For the BWP 405, two CORESETs are configured. As above-mentioned, a RRC parameter frequencyDomainResource in respective CORESET configuration indicates the frequency domain resource for respective CORESET. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET#1. That is, the first RB group, the second RB group, and the fourth RB group belong to the frequency domain resource of the CORESET#1. Additionally, the RRC parameter frequencyDomainResource provides a bit string with a fixed size (e.g. 45 bits) as like ‘00101110 . . . 000000’ for CORESET #2. That is, the third RB group, the fifth RB group, the sixth RB group and the seventh RB group belong to the frequency domain resource of the CORESET#2.

For the BWP 407, one CORESET is configured. As above-mentioned, a RRC parameter frequencyDomainResource in the CORESET configuration indicates the frequency domain resource for the CORESET#3. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET#3. That is, the first RB group, the second RB group, and the fourth RB group belong to the frequency domain resource of the CORESET#3. Although the bit string configured for CORESET#3 is same as that for CORESET#1, the first RB group of the BWP B is different from that of the BWP A in the carrier. Therefore, the frequency domain resource of the CORESET#3 in the carrier is different from that of the CORESET#1 as well.

For the communication system, spectrum is divided into licensed spectrum and unlicensed spectrum. The NR technologies have been developed in the licensed spectrum and in the unlicensed spectrum. The operation in unlicensed spectrum, used as a complementary solution, can increase the throughput of the overall wireless communication system. However, operation in unlicensed spectrum is subject to regulatory limitations and restrictions. For example, the European Telecommunications Standards Institute (ETSI) has defined regulations for operation over the unlicensed spectrum. For example, the occupied channel bandwidth (OCB), which is defined as a bandwidth containing 99% of the signal power, should be larger than a percentage of the nominal channel bandwidth (NCB). For example, according to the ETSI regulations, the OCB should be between 70% and 100% of the NCB for 5 GHz band.

For example, an unlicensed band (or a channel bandwidth, or a subband) would be divided into multiple non-overlapping channels of 20 MHz bandwidth. Interlaced transmission had been introduced to ensure the compliance with the regulations for OCB and NCB. Specifically, the interlaced transmission is designed such that each interlaces can occupy the channel bandwidth where the occupied channel bandwidth can fulfill the requirement of the NCB.

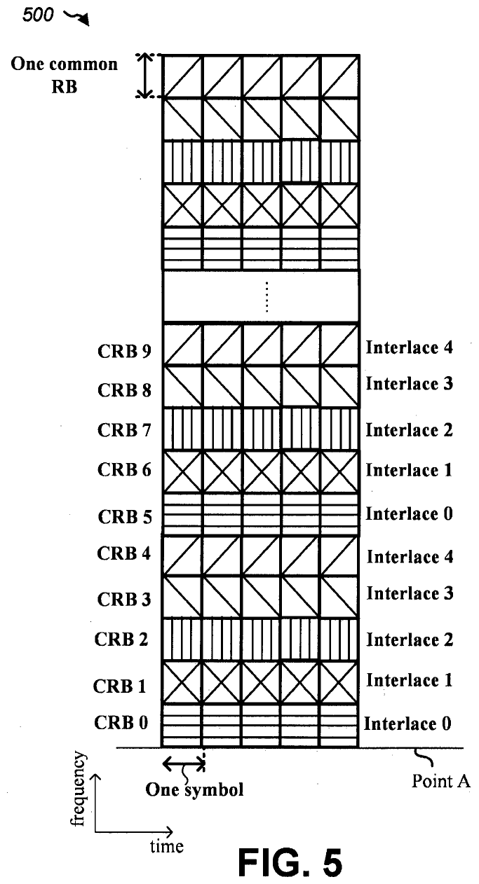

FIG. 5 is a diagram illustrating one example 500 for interlaced resource blocks for transmission and reception. In the FIG. 5, each block in the frequency domain refers to a common resource block. In the FIG. 5, the subcarrier spacing is configured as 30 kHz and the number of resource block interlaces, which is denoted as M, are 5. Then the interlaces would be indexed from 0 to M−1. That is, an interlace m, where m=0, 1, . . . , M−1, consists of a plurality of common resource blocks with index {m, M+m, 2M+m, 3M+m, . . . }. For example, in the FIG. 5, the interlace m=0 consists of common resource blocks with indexes {0, 5, 10, 15, . . . }, the interlace m=1 consists of common resource blocks with indexes {1, 6, 11, 16, . . . }, and so on.

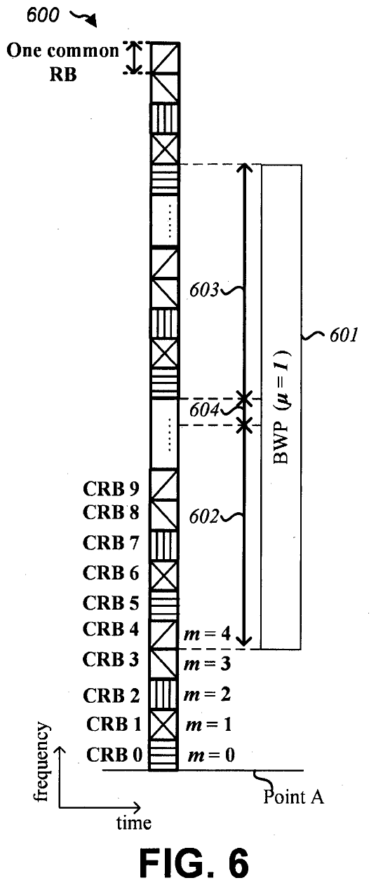

FIG. 6 is a diagram illustrating one example 600 of interlaced mapping for a BWP. The number of resource block interlaces M may be specific to a SCS. If the SCS is equal to 15 kHz, the number of resource block interlaces M is correspondingly equal to 10. If the SCS is equal to 30 kHz, the number of resource block interlaces M is correspondingly equal to 5. In the FIG. 6, the subcarrier spacing is configured as 30 kHz and the number of resource block interlaces M are 5. In the frequency domain, a BWP 601 is determined as specified in FIG. 3.

An interlaced resource block in the BWP is denoted as n_{IRB,m}^{μ} where the n_{IRB,m}^{μ} is indexed from 0, 1, . . . , in the BWP. The relation between the interlace resource block n_{IRB,m}^{μ} and interlace m and the common resource block n_{CRB}^{μ} is given by n_{CRB}^{μ}=Mn_{IRB,m}^{μ}+N_{BWP}^{start,μ}+ ((m−N_{BWP}^{startμ})mod M). The N_{BWP}^{startμ} is the common resource block where the BWP starts relative to common resource block 0 (i.e., a common resource block with index 0). In the FIG. 6, the BWP 601 starts in a CRB with index 4 relative to the CRB with index 0.

At least for NR-U operation in, for example, 5 GHz spectrum, a BWP may have a bandwidth of multiple of 20 MHz. A sub-band may comprise 20 MHz or a multiple of 20 MHz bandwidth. A sub-band may also be referred to as a sub-channel, or a channel access bandwidth (e.g., a channel of 20 MHz). Then a BWP may include one or more sub-bands in the frequency domain. A sub-band consists of multiple non-overlapping RBs. The number of resource blocks within a sub-band may depend on the SCS of the BWP. For example, the sub-band size for SCS=15 kHz may be equal to 108 for a 40 MHz BWP, and the sub-band size for SCS=30 kHz may be equal to 53 for a 40 MHz BWP. That is, a sub-band is an RB set of non-overlapping and contiguous (common) resource blocks. And a sub-band can be defined by a starting common RB and an ending common RB in the frequency domain. Hereinafter, an RB set is used to refer to a sub-band. In other words, an RB set consists of non-overlapping resource blocks and can be defined by a starting common RB and an ending common RB.

As in the FIG. 6, the BWP 601 includes two RB sets, i.e., a RB set 602 and a RB set 603. The RB sets within a BWP can be indexed from 0 in an increase order along with the frequency. According to higher layer (RRC) configurations, there may be a gap 604 between two consecutive RB set. The gap in unit of resource block can be indicated by the higher layer configurations. Additionally or alternatively, there may be no gap between two RB sets. In other words, there may be a separation of zero, one, or more RBs between two contiguous RB sets within the BWP in the frequency domain.

In the FIG. 6, in the frequency domain, a interlace whose RBs have a lowest CRB index within the first RB set is the interlace m=4, while the interlace whose RBs have a lowest CRB index within the second RB set is the m=0.

In order to ensure a fair co-existence with another NR-U node and/or another radio access technology (RAT) node such as wireless LAN node, the gNB 160 and/or the UE 102 may have to perform Listen Before Talk (LBT) procedure before their transmissions. LBT procedure is also referred to as Channel Access procedure. There may be several types of Channel Access (CA) procedures. For example, Cat-1 LBT is a channel access procedure without channel sensing. Cat-2 LBT is a channel access procedure with one shot channel sensing. Cat-2 LBT may also be referred to as Type-2 channel access procedure. Cat-1 and Cat-2 LBTs may be allowed only inside COT. Cat-3 LBT is a channel access procedure with random backoff with a fixed contention window (CW) size. Cat-4 LBT is a channel access procedure with random backoff with an adaptive CW size. Cat-4 LBT may also be referred to as Type-1 channel access procedure.

In a BWP, before a gNB and/or a UE attempt to transmit a signal, the gNB and/or the UE may first perform channel sensing in each RB set to check whether a channel (or one or more RB sets within the BWP allocated for transmission) is available or not for transmission. If the channel or the allocated RB set(s) is sensed to be considered to be idle (i.e., the channel is available for transmission or the gNB and/or the UE gets a channel access successfully), the gNB and/or the UE may transmit on the channel or on the allocated RB set(s). On the other hand, if the channel or the allocated RB set(s) is sensed to be considered to be busy (i.e., the channel is not available or the gNB and/or the UE does not get a channel access successfully), the gNB and/or the UE may not transmit on the channel or on the allocated RB set(s).

Vehicle-to-everything (V2X) communication technologies have been developed by 3GPP for the automotive industry. V2X refers to a communication technology through which a vehicle exchanges information with another vehicle, a pedestrian, an object having an infrastructure, and so on. The V2X is divided into 4types, such as vehicle-to-vehicle (V2V), vehicle-to-infrastructure (V2I), vehicle-to-network (V2N), and vehicle-to-pedestrian (V2P). Therefore, the V2X communication is different from the communication between the UEs and gNBs. The V2X communication enables the communication between the UEs, which is also called as sidelink. That is, sidelink communication supports UE-to-UE direct communication via a PC5 interface. In other words, sidelink communication is directly performed or communicated between one transmitting UE and one or more receiving UEs.

Sidelink communication consists of unicast, groupcast and broadcast. The unicast may refer to a communication between two UEs, i.e., one transmitting UE and one receiving UE. The groupcast and/or the broadcast may refer to a communication between one transmitting UE and multiple receiving UEs.

Currently NR Sidelink communication supports two sidelink resource allocation modes, mode 1 and mode 2. In mode 1, the sidelink resource allocation is provided by the base station and/or the network. For example, a base station may allocate the resources for sidelink communication to an in-coverage UE. In mode 2, a UE decides the sidelink transmission resources in resource pool(s). The UE may autonomously determine to select resources for sidelink communication based on a sensing procedure.

Sidelink communication supports physical channels such as Physical Sidelink Control Channel (PSCCH), Physical Sidelink Shared Channel (PSSCH), Physical Sidelink Feedback Channel (PSFCH), and Physical Sidelink Broadcast Channel (PSBCH).

PSCCH indicates resource and other transmission parameters used by a UE for PSSCH. PSCCH transmission is associated with a DM-RS.

PSSCH transmits the TBs of data themselves, and control information for HARQ procedures and CSI feedback triggers, etc. At least 6 OFDM symbols within a slot are used for PSSCH transmission. PSSCH transmission is associated with a DM-RS and may be associated with a PT-RS.

PSFCH is used to carry HARQ feedback over the sidelink from a UE which is an intended recipient of a PSSCH transmission to the UE which performed the PSSCH transmission. PSFCH sequence is transmitted in one PRB repeated over two OFDM symbols near the end of the sidelink resource in a slot.

PSBCH occupies 9 and 7 symbols for normal and extended CP cases respectively, including the associated DM-RS.

Sidelink communication supports physical signals such as demodulation reference signal (DM-RS), phase-tracking reference signal (PT-RS), channel-state information reference signal (CSI-RS), sidelink synchronization signals.

The DMRS(s) are associated with PSCCH, PSSCH and/or PSBCH. A transmitting UE may transmit the DMRS within the associated sidelink physical channel. A receiving UE may use the DMRS to decode the associated sidelink physical channel.

The PT-RS is used to mitigate the effect of phase noise. A transmitting UE may transmit the PT-RS within the PSSCH transmission. The receiving UE may receive the PT-RS and use the PT-RS to mitigate the effect of phase noise.

The CSI-RS is used for measuring channel state information. A transmitting UE may transmit sidelink CSI-RS within a unicast PSSCH transmission. A receiving UE may measure the channel state information by using the CSI-RS and transmit a CSI report based on the measurement to the transmitting UE.

The Sidelink synchronization signal consists of sidelink primary and sidelink secondary synchronization signals (S-PSS, S-SSS), each occupying 2 symbols and 127 subcarriers.

In various implementations of the present disclosure, a UE may be provided NR sidelink communication (pre-)configuration(s). For simplicity, (pre-)configuration(s) hereinafter refer to the NR sidelink communication (pre-)configuration(s). (Pre-)configuration(s) in the present disclosure may include configuration(s) received by system information (e.g., SIB 12) from a base station, configuration(s) received by dedicated RRC signaling (e.g., RRC configuration/parameters/message) from a base station, and/or configuration(s) preconfigured in the UE.

In various examples or implementations of the present disclosure, (pre-)configuration(s) may include configuration(s) of one or more sidelink BWPs for sidelink communication. That is, the configuration(s) of the one or more BWPs may be received in system information, received in dedicated RRC signaling, and/or preconfigured in a pre-configuration. In the present disclosure, a UE may be provided by the (pre-)configuration(s) a BWP for sidelink transmissions.

In various examples or implementations of the present disclosure, a SL BWP configuration may include configuration(s) of one or more resource pools for sidelink communication. That is, the configuration(s) of the one or more resource pools (the configuration(s) related to the one or more resource pools) may be received in system information, received in dedicated RRC signaling, and/or preconfigured in a pre-configuration. According to the configuration(s), a resource pool may be indicated to be used either for sidelink communication reception or for sidelink communication transmission. Additionally or alternatively, a resource pool may be indicated to be used for both sidelink communication reception and sidelink communication transmission.

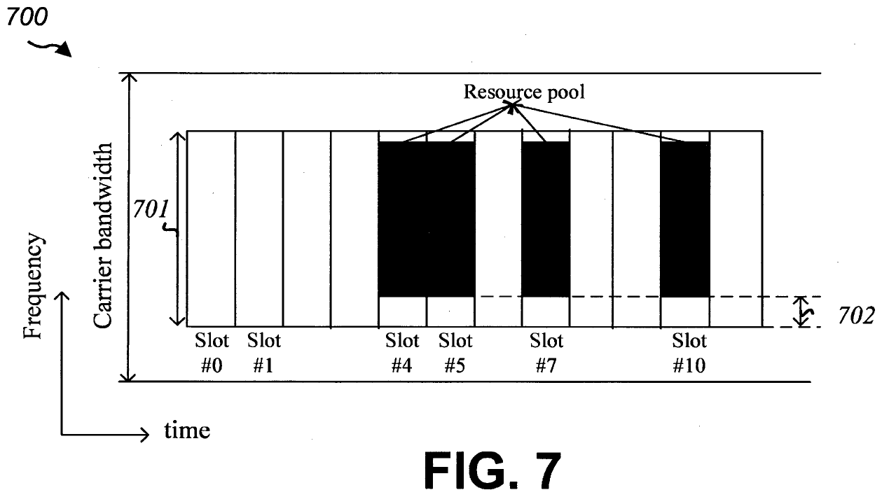

FIG. 7 is a diagram illustrating one example 700 of a SL BWP and a resource pool within the SL BWP.

A UE 102 is provided by a parameter SL-BWP-Config a BWP (a SL BWP) for sidelink transmission with numerology and resource grid. The determination of a SL BWP 701 is similar as how to determine a BWP specified in the FIG. 3.

In the FIG. 7, each block in the time domain represents a slot. One resource pool is configured within the SL BWP 701. The resource pool can be for transmission of PSSCH, PSCCH and/or PSFCH, and/or for reception of PSSCH, PSCCH and/or PSFCH. The first RB of the resource pool relative to the first RB of SL BWP, 702, may be indicated by a parameter included in the (pre-)configurations.

Not all the slots within the SL BWP may be assigned to a resource pool within the SL BWP. That is, not all the slots may belong to a resource pool. A slot assigned to a resource pool (or a slot belongs to a resource pool) can be also referred to a slot available for the resource pool. On the contrary, a slot not assigned to a resource pool (or a slot does not belong to a resource pool) can be also referred to a slot unavailable for the resource pool. Therefore, a resource pool may consist of a plurality (set) of non-contiguous slots in the time domain. In a SL BWP, different resource pools may be assigned with different sets of slots. The UE may determine the set of slots assigned to a resource pool according to the (pre-)configurations. A transmitting UE may transmit one or more physical SL channels or one or more SL signals in one or more resource pools within a SL BWP, while a receiving UE may receive one or more physical SL channels or one or more SL signals in one or more resource pools within a SL BWP.

In the FIG. 7, slot#0 refers to a first slot of a radio frame corresponding to SFN 0 of the serving cell or DFN 0. As illustrated in the FIG. 7, a set of slots with indexes#4, #5, #7 and #10 belong to the resource pool. The slots in the set for a resource pool are re-indexed such that the logical slot indexes are successive from 0 to T′ₘₐₓ−1 where the T′ₘₐₓ is the number of the slot in the set. For example, in the FIG. 7, the four slots in the set can be re-indexed as slots with logical slot indexes 0, 1, 2, and 3. The slots available for a resource pool may be provided or indicated by a parameter sl-TimeResource and may occur with a periodicity of 10240 ms.

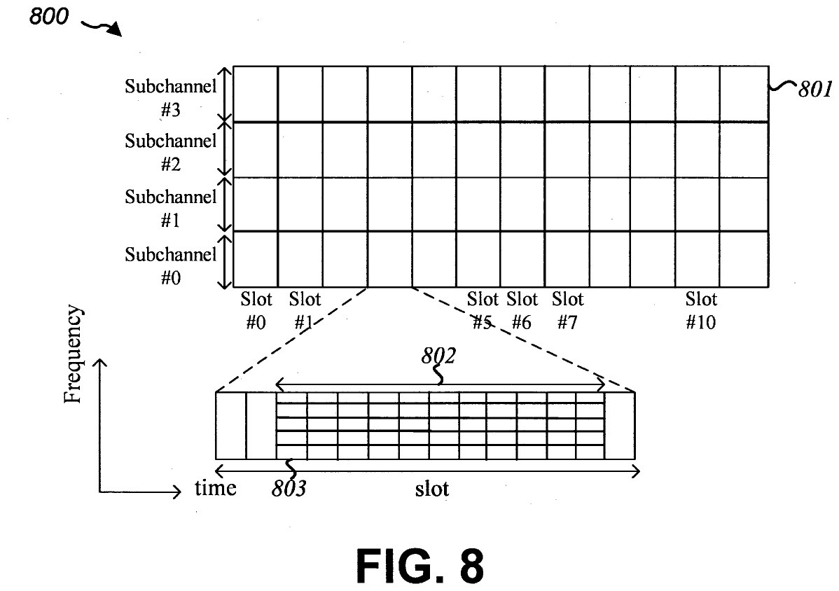

FIG. 8 is a diagram illustrating one example 800 of a resource pool configuration in time and frequency domain.

In the frequency domain, a resource pool within a SL BWP can be divided into one or multiple contiguous sub-channels in the frequency domain. The number of the one or multiple sub-channels is indicated by a parameter sl-NumSubchannel included in the configuration of the resource pool. Each sub-channel includes a number of contiguous RBs. The number of contiguous RBs is indicated by a parameter sl-SubchannelSize included in the configuration of the resource pool. In the FIG. 8, each block in the frequency domain represent a sub-channel of the resource pool 801. For example, in the FIG. 8, the resource pool 801 consists of 4 sub-channels which is indicated by the parameter sl-NumSubchannel. The first RB of the first sub-channel of the resource pool 801 in the SL BWP may be indicated by a parameter sl-StartRB-Subchannel.

In the time domain, each block in the time domain represents a slot in the set of slots assigned to the resource pool 801. The slot indexes in the FIG. 8 refer to the logical slot indexes. The OFDM symbols within a slot assigned for sidelink transmission are provided by parameters included in the (pre-)configuration.

For example, SL transmissions can start from a first symbol indicated by a parameter sl-StartSymbol and be within a number of consecutive symbols indicated by a parameter sl-LengthSymbols. As in the FIG. 8, the duration 802 starts at the third OFDM symbol which is indicated by the parameter sl-StartSymbol and consists of 11 consecutive OFDM symbols which is indicated by the parameter sl-LengthSymbols. For a slot indicated for transmission of S-SS/PSBCH blocks, the first symbol and the number of consecutive symbols is predetermined.

A UE received a PSSCH transmission may transmit sidelink HARQ feedback via PSFCH to another UE which transmitted the PSSCH. Sidelink HARQ feedback can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs. Additionally, in sidelink resource allocation mode 1, a UE which received PSFCH can report sidelink HARQ feedback to gNB via PUCCH or PUSCH.

In NR Release 16/17, sidelink communication was developed to operate in licensed spectrum. In NR Release 18, to further support commercial use cases with increased sidelink data rate, sidelink over unlicensed spectrum is under discussion. As above-mentioned, operation over unlicensed spectrum should fulfill different regulatory limitations and restrictions.

However, the existing solution of HARQ feedback transmission on PSFCH, which is transmitted in one PRB in frequency domain, does not fulfill the OCB requirement if the HARQ feedback is transmitted over the unlicensed spectrum. That is, the existing solution of HARQ feedback transmission on PSFCH cannot be applied to sidelink communication over unlicensed spectrum. Therefore, interlaced HARQ transmission over PSFCH should be introduced for sidelink communication over unlicensed spectrum such that the regulatory requirements can be fulfilled. The present disclosure provides new methods/solutions on how to determine the PSFCH resource for interlaced PSFCH transmission as below, which would provide a more efficient and flexible sidelink communication over unlicensed spectrum.

In various implementations of the present disclosure, the sidelink transmissions are operated over unlicensed spectrum. In the frequency domain, a resource pool may include one or more RB sets according to the configured bandwidth of the resource pool. In other words, a resource pool may be divided into one or more RB sets, where each of one or more RB sets does not overlap with each other in the frequency domain. That is, the one or more RB sets do not have overlapping RBs in the frequency domain. The one or more RB sets within the resource pool are indexed from 0 in the order of increasing frequency of the one or more RB sets.

One RB set consists of a plurality of contiguous common resource blocks and can be defined by a starting common RB and an ending common RB in the frequency domain. For different SCSs, one RB set may include different numbers of resource blocks. For example, in a case that subcarrier spacing equals to 15 KHz, the number of resource blocks within an RB set may be configured to be between 100 and 110. In a case that subcarrier spacing equals to 30 kHz, the number of resource blocks within an RB set may be configured to be between 50 and 55. However, as an exception, for a resource pool, at most one RB set may be configured to contain 56 resource blocks. Specifically, a single RB set is defined by a starting common RB and an ending common RB in the frequency domain.

Additionally or alternatively, zero, one or multiple RBs may be used as guard band to separate two consecutive RB sets amongst a plurality of RB sets within a resource pool.

Furthermore, each RB within a resource pool is mapped to an interlace. In other words, in the present disclosure, a resource pool may consist of a plurality of interlaces. In the frequency domain, a resource pool is divided into a number of interlaces M where each interlace consists of non-contiguous (common) resource blocks. As above-mentioned, the value of M is determined per SCS.

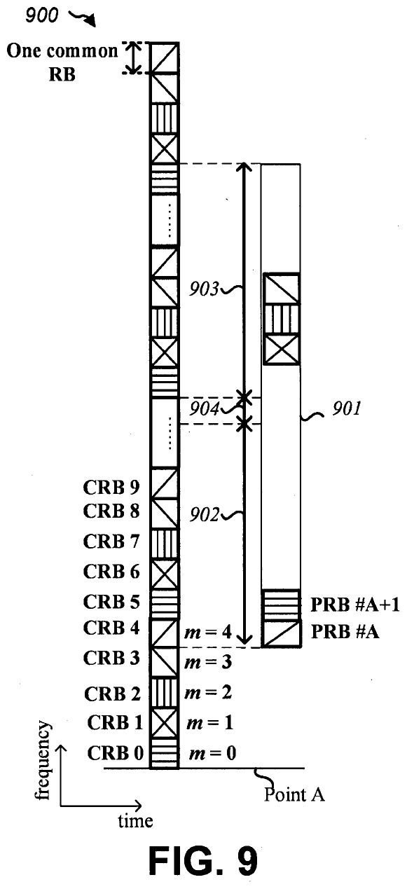

FIG. 9 is a diagram illustrating one example 900 of PSSCH allocation in an resource pool.

In the FIG. 9, the resource pool 901 starts in a RPB with index A relative to the starting PRB of the SL BWP (i.e. PRB with index 0). In the FIG. 9, the subcarrier spacing is configured as 30 kHz and the number of resource block interlaces M are 5. Each RB of the resource pool is mapped to an interlace. For example, the PRB with index A is mapped to interlace m=4, the PRB with index A+1 is mapped to interlace m=0, and so on. A resource pool 901 is configured to include two RB sets in the frequency domain, i.e. the RB set 902 and the RB set 903. A gap separation 904 between the two RB sets may include zero, one or more RBs.

SCI format 1-A may indicate or assign the frequency resource for PSSCH transmission where the frequency resource includes one or more interlaces and one or more RB sets. As shown in the FIG. 9, a PSSCH transmission is allocated in both RB sets 902 and 903. Furthermore, two interlaces m=0 and 4 within the RB set 902 are assigned for PSSCH transmission, while three interlaces m=1, 2 and 3 within the RB set 903 are assigned for PSSCH transmission. Then resource blocks of interlaces m=0 and 4 within the RB set 902 and resource blocks of interlaces m=1, 2 and 3 within the RB set 903 are used for PSSCH transmission.

In various implementations of the present disclosure, a PSFCH resource for HARQ feedback transmission in response to the reception of a PSSCH is implicitly determined based on its associated PSCCH and/or its associated PSSCH. The PSFCH transmission is interlaced transmission. A PSFCH resource used for PSFCH transmission is implicitly determined based on an interlace index allocated for the PSSCH and an RB set index allocated for the PSSCH.

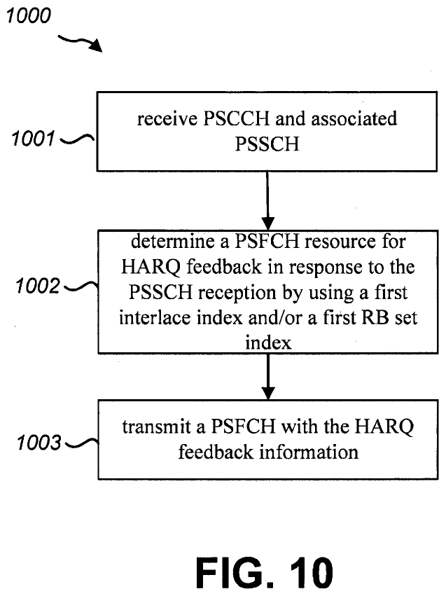

FIG. 10 is a flow diagram illustrating one implementation of a method 1000 for determine a PSFCH resource for HARQ feedback transmission by a UE 102. In the implementation of the present disclosure, a resource pool within a SL BWP is selected by the UE 102 (i.e., a receiving UE, a second UE, or a RX UE) for PSCCH/PSSCH reception. Meanwhile, in response to reception of the PSCCH and PSSCH, the RX UE may transmit the HARQ feedback on PSFCH in the resource pool within the SL BWP. In the implementation, the transmission and/or the reception of the PSCCH, the PSSCH and/or the PSFCH are performed in the interlaced basis.

In 1001, a RX UE may receive, from a TX UE, a PSCCH and associated PSSCH. The PSCCH carries a SCI format 1-A, which is also called as a 1^{st}-stage SCI format. The SCI format 1-A is used for the scheduling of an associated PSSCH and a 2^{nd}-stage SCI format on the PSSCH. The 2^{nd}-stage SCI format (e.g., SCI format 2-A or 2-B) is used for the decoding of the PSSCH. In addition, the SCI format 1-A can indicate which one of a SCI format 2-A or a SCI format 2-B on the PSSCH.

A number of interlaces used for PSCCH transmission in a slot may be pre-configured or indicated in the above-mentioned (pre-)configuration(s). Similarly, a number of symbols used for PSCCH transmission within a slot may be pre-configured or indicated in the (pre-)configuration(s). In other words, the Rx UE may determine one or more interlaces for PSCCH reception in a slot according to the (pre-)configuration(s). One PSCCH reception or a PSCCH candidate detection may be performed within an RB set of the resource pool. The RX UE may blindly detect a PSCCH candidate in each RB set of the resource pool. That is, the PSCCH reception may be confined within one RB set amongst the one or more RBs set of the resource pool. That is, the RBs of the one or more interlaces used for PSCCH transmission are within one RB set in the frequency domain.

Upon the successful detection of the PSCCH, the RX UE may derive the SCI format 1-A. The SCI format 1-A includes a frequency resource assignment field to indicate or allocate the frequency resource for a PSSCH scheduled by the SCI format 1-A. The RX UE may determine, based on the frequency resource assignment field, one or more interlaces which are allocated or indicated for the scheduled PSSCH reception. Furthermore, the RX UE may determine, based on the frequency resource assignment field, one or more RB sets which are allocated or indicated for the scheduled PSSCH transmission. In other words, the scheduled PSSCH by the SCI format 1-A is transmitted over one or more interlaces in one or more RB sets within the resource pool.

Additionally, the SCI format 1-A includes a time resource assignment field to indicate one or multiple slots where the PSSCH is transmitted. The SCI format 1-A may include other fields such as a Modulation and coding scheme field, a priority field, a resource reservation period field, and so on.

According to the SCI format 1-A, the RX UE may receive the PSSCH in the determined frequency resource and the determined time resource. In response to the PSSCH reception, the RX UE may provide HARQ-ACK feedback information to the TX UE. The RX UE may determine 1002 a PSFCH resource for the HARQ feedback transmission. A PSFCH resource in the frequency domain can be defined by or can correspond to an interlace and/or an RB set. A PSFCH resource in the frequency domain may consist of multiple RBs.

The RX UE may determine 1002, the PSFCH resource in frequency domain based on a first interlace index and/or a first RB set index wherein the first interlace index is an index of one interlace allocated for PSSCH reception and the RB set index is an index of an RB set allocated for PSSCH reception. In other words, the RX UE May 1002 use a first interlace index and/or a first RB set index to determine the PSFCH resource in frequency domain wherein the first interlace index is an index of one interlace allocated for PSSCH reception and the first RB set index is an index of an RB set allocated for PSSCH reception. Herein, ‘a first interlace index’, ‘an interlace with a first index’ and ‘a first interlace’ may be used interchangeably. Likewise, ‘a first RB set index’, ‘an RB set with a first index’ and ‘a first RB set’ may be used interchangeably.

The determination of the PSFCH resource may include two steps, i.e., determination of an RB set and determination of an interlace. These two steps are not in any particular order. The RX UE may perform these two steps in any order or may simultaneously perform these two steps. For example, the RX UE may first determine an RB set, i.e., the RB set with the first index, within the resource pool. The resource blocks used for HARQ feedback may be limited or confined within the determined RB set. In other words, the RX UE may use the resource blocks within the determined RB set for HARQ transmission and may not use the resource blocks outside the determined RB set for HARQ transmission. The RX UE may further determine an interlace, i.e., the interlace with the first index, for the HARQ feedback transmission. Specifically, for the RBs of the determined interlace, if an RB of the determined interlace is within the determine RB set in the frequency domain, the RB of the determined interlace is determined by the RX UE to be used for HARQ feedback transmission. If an RB of the determined interlace is outside the determined RB set in the frequency domain, the RB of the determined interlace is determined by the RX UE not to be used for HARQ feedback transmission. That is, the RX UE may determine the resource blocks used for the PSFCH resource as the resource blocks of the determined interlace which are within the determined RB set in the frequency domain. Additionally or alternatively, the RX UE may determine the resource blocks used for the PSFCH resource as the intersection of resource blocks of the determined interlace and resource blocks of the determined RB set.

According to an example of the implementation, the first RB set index is determined as a lowest RB set index amongst one or more RB sets wherein the one or more RB sets are allocated for the PSSCH reception. That is, the RX UE may select, from the one or more RB sets which are allocated or scheduled for the PSSCH reception, an RB set which has a lowest RB set index amongst the one or more RB sets. Then the RX UE may determine the selected RB set index as the first RB set index. In the example, as shown in the FIG. 9, the RB set 902, which has a lowest RB set index amongst the RB sets assigned to the PSSCH reception, may be determined as the first RB set.

According to an example of the implementation, the first RB set index is determined as an index of an RB set amongst one or more RB sets wherein the one or more RB sets are allocated for the PSSCH reception. The first RB set is an RB set where the RX UE performed channel sensing in the RB set and may determine the RB set is available for transmission. In a case that there are more than one RB sets, amongst the one or more RB sets, which are determined to be available for transmission by the RX UE, the RX UE may select, amongst the more than one RB sets, an RB set with the lowest RB set index as the first RB set. Additionally or alternatively, the RX UE may randomly select an RB set amongst the more than one RB sets as the first RB set.

According to an example of the implementation, the first interlace index is determined as a lowest interlace index amongst one or more interlaces wherein the one or more interlaces are the interlaces which are allocated within the first RB set for the PSSCH reception. In the example, the interlaces allocated within an RB set for PSSCH reception may be different from the interlaces allocated within another RB set for PSSCH reception. To be specific, the number of interlaces allocated within an RB set for PSSCH reception may be different from the number of interlaces allocated within another RB set for PSSCH reception. Additionally or alternatively, the interlace indexes allocated within an RB set for PSSCH reception may be different from the interlace indexes allocated within another RB set for PSSCH reception.

In the example, as shown in the FIG. 9, in a case that the RB set 902 is determined as the first RB set, the interlace m=0 may be determined as the first interlace index. In a case that the RB set 903 is determined as the first RB set, the interlace m=1 may be determined as the first interlace index.

According to an example of the implementation, the first interlace index is determined as a lowest interlace index amongst the one or more interlaces wherein the one or more interlaces are allocated for the PSSCH reception.

According to an example of the implementation, the first interlace index is determined as an index of an interlace amongst one or more interlaces wherein the one or more interlaces are the interlaces which are allocated within the first RB set for the PSSCH reception and the interlace has a RB with the lowest CRB index within the first RB set. In the example, as shown in the FIG. 9, in a case that the RB set 902 is determined as the first RB set, the interlace m=4, which has a RB with the lowest CRB index, may be determined as the first interlace index. In a case that the RB set 903 is determined as the first RB set, the interlace m=1, which has a RB with the lowest CRB index, may be determined as the first interlace index.

According to an example of the implementation, the first RB set index is determined as an index of an RB set where the PSCCH is received. Then the first interlace index may be determined as an index of an interlace where the PSCCH is received. In a case that there are more than one interlaces'used for PSCCH reception, the first interlace index may be determined as a lowest interlace index amongst the more than one interlaces used for PSCCH reception.

After determining the PSFCH resource for HARQ feedback transmission, the RX UE may transmit 1003, to the TX UE, the PSFCH with the HARQ feedback transmission.

In the implementation, the RX UE may send the HARQ feedback on a PSFCH resource in response to a unicast PSSCH reception or a groupcast PSSCH reception. The HARQ feedback is enabled by the 2^{nd} stage SCI. The RX UE may combinedly use one, more or all of the above-mentioned examples to determine the PSFCH resource for HARQ feedback.

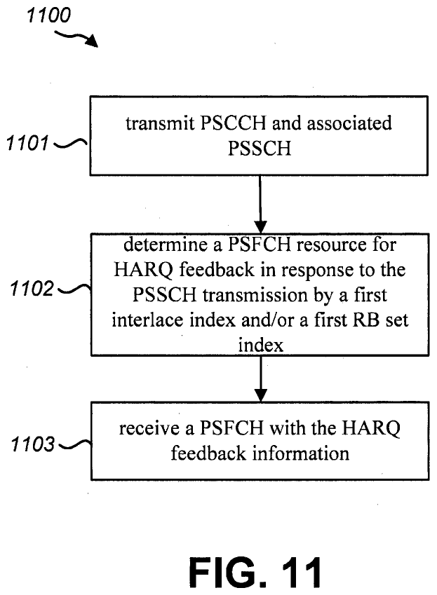

FIG. 11 is a flow diagram illustrating one implementation of a method 1100 for determine a PSFCH resource for HARQ feedback reception by a UE 102. In the implementation of the present disclosure, a resource pool within a SL BWP is selected by the UE 102 (i.e., a transmission UE, a first UE, or a TX UE) for PSCCH/PSSCH transmission. Meanwhile, the TX UE, which transmitted the PSCCH/PSSCH, attempts to receive the HARQ feedback on PSFCH in the resource pool within the SL BWP. In the implementation, the transmission and/or the reception of the PSCCH, the PSSCH and/or the PSFCH are performed in the interlaced basis.

A TX UE may transmit 1101, to a RX UE, a PSCCH and associated PSSCH. The PSCCH carries a SCI format 1-A which schedules the associated PSSCH.

A number of interlaces used for PSCCH transmission in a slot may be pre-configured or indicated in the above-mentioned (pre-)configuration(s). Similarly, a number of symbols used for PSCCH transmission within a slot may be pre-configured or indicated in the (pre-)configuration(s). In other words, the TX UE may determine one or more interlaces for PSCCH transmission in a slot according to the (pre-)configuration(s). Then the TX UE may further determine to use one RB set within the resource pool to be used for PSCCH transmission.

The TX UE may determine the frequency resource for the PSSCH transmission. The determined frequency resource includes one or more interlace assigned to the PSSCH transmission and one or more RB sets assigned to the PSSCH transmission. Then the TX UE may generate the frequency resource assignment field in the SCI format 1-A to indicate the assigned frequency resource to RX UE(s). Likewise, the TX UE may generate the time resource assignment field to indicate one or multiple slots (the time resource) where the PSSCH is determined to be transmitted. Additionally, the TX UE may generate, in the SCI format 1-A, other fields such as a Modulation and coding scheme field, a priority field, a resource reservation period field, and so on.

Then the TX UE may transmit the PSCCH carrying the SCI format 1-A over the determined one or more interlaces and the determined one RB set within the resource pool. While the PSCCH transmission may be confined within one RB set amongst the one or more RBs set of the resource pool. That is, the RBs of the one or more interlaces used for PSCCH transmission are within one RB set in the frequency domain.

The TX UE may transmit the PSSCH in the determined frequency resource and the determined time resource. After transmitting the PSSCH, the TX UE may attempt to receive associated PSFCH in a PSFCH resource.

The TX UE may determine 1102, the PSFCH resource in frequency domain based on a first interlace index and/or a first RB set index wherein the first interlace index is an index of one interlace allocated for PSSCH transmission and the RB set index is an index of an RB set allocated for PSSCH transmission. In other words, the TX UE May 1102 use a first interlace index and/or a first RB set index to determine the PSFCH resource in frequency domain wherein the first interlace index is an index of one interlace allocated for PSSCH transmission and the first RB set index is an index of an RB set allocated for PSSCH transmission. Herein, ‘a first interlace index’, ‘an interlace with a first index’ and ‘a first interlace’ may be used interchangeably. Likewise, ‘a first RB set index’, ‘an RB set with a first index’ and ‘a first RB set’ may be used interchangeably.

The determination of the PSFCH resource may include two steps, i.e., determination of an RB set and determination of an interlace. These two steps are not in any particular order. The TX UE may perform these two steps in any order or may simultaneously perform these two steps. For example, the TX UE may first determine an RB set, i.e., the RB set with the first index, within the resource pool. The resource blocks used for HARQ feedback may be limited or confined within the determined RB set. In other words, the TX UE may use the resource blocks within the determined RB set for HARQ reception and may not use the resource blocks outside the determined RB set for HARQ reception. The TX UE may further determine an interlace, i.e., the interlace with the first index, for the HARQ feedback reception. Specifically, for the RBs of the determined interlace, if an RB of the determined interlace is within the determine RB set in the frequency domain, the RB of the determined interlace is determined by the TX UE to be used for HARQ feedback reception. If an RB of the determined interlace is outside the determined RB set in the frequency domain, the RB of the determined interlace is determined by the TX UE not to be used for HARQ feedback reception. That is, the TX UE may determine the resource blocks used for the PSFCH resource as the resource blocks of the determined interlace which are within the determined RB set in the frequency domain.

According to an example of the implementation, the first RB set index is determined as a lowest RB set index amongst one or more RB sets wherein the one or more RB sets are allocated for the PSSCH reception. That is, the TX UE may select, from the one or more RB sets which are allocated or scheduled for the PSSCH transmission, an RB set which has a lowest RB set index amongst the one or more RB sets. Then the TX UE may determine the selected RB set index as the first RB set index.

According to an example of the implementation, the TX UE may randomly select an RB set amongst one or more RB sets as the first RB set wherein the one or more RB sets are allocated for the PSSCH transmission.

According to an example of the implementation, the first interlace index may be determined as a lowest interlace index amongst one or more interlaces wherein the one or more interlaces are the interlaces which are allocated within the first RB set for the PSSCH transmission. In the example, the interlaces allocated within an RB set for PSSCH transmission may be different from the interlaces allocated within another RB set for PSSCH transmission. To be specific, the number of interlaces allocated within an RB set for PSSCH transmission may be different from the number of interlaces allocated within another RB set for PSSCH transmission. Additionally or alternatively, the interlace indexes allocated within an RB set for PSSCH transmission may be different from the interlace indexes allocated within another RB set for PSSCH transmission.

According to an example of the implementation, the first interlace index may be determined as a lowest interlace index amongst the one or more interlaces wherein the one or more interlaces are allocated for the PSSCH transmission.

According to an example of the implementation, the first interlace index is determined as an index of an interlace amongst one or more interlaces wherein the one or more interlaces are the interlaces which are allocated within the first RB set for the PSSCH transmission and the interlace has a RB with the lowest CRB index within the first RB set.

After determining the PSFCH resource for HARQ feedback reception, the TX UE may receive 1103, from the RX UE, the PSFCH carrying the HARQ feedback information.

Additionally or alternatively, in the above-mentioned implementations of the present disclosure, after determining the PSFCH resource for HARQ feedback transmission, the RX UE may determine to select which PSFCH format of a first PSFCH format and a second PSFCH format based on the number of HARQ-ACK information bits to be transmitted in the PSFCH resource. In a case that the number of HARQ-ACK information bit(s) does not exceed the first value, the first PSFCH format is used for the HARQ feedback transmission in the PSFCH resource. In a case that the number of HARQ-ACK information bit(s) exceeds the first value, the second PSFCH format is used for the HARQ feedback transmission in the PSFCH resource. The first value may be 1 bit or 2 bits.

The first PSFCH format is similar as the PUCCH (PSFCH) format 0, where a low PAPR sequence (i.e. Zadoff-Chu sequence) with a length (e.g., 12) is used as a base sequence for the first PSFCH format. In a case the low PAPR sequence is generated with length 12, the RX UE may repeat the generate sequence over each RB of the PSFCH resource.

Different from the first PSFCH format which is based on sequence selection (a base sequency with different cyclic shifts), the second PSFCH format modulates the HARQ-ACK information bits using QPSK where the HARQ-ACK information bits and associated DMRS are multiplex in frequency (for example, in different resource elements in RBs of the PSFCH resource). The design of the second PSFCH format may be similar as the PUCCH format 2.

In above-mentioned implementation of the present disclosure, a new RRC parameter included in system information is introduced to indicate the UE 102 how to calculate the PRB index of the PUCCH resource for PUCCH transmission. Introduction of a new RRC parameter would cause overhead of broadcasted system information. Instead of introducing a new RRC parameter in system information, implicit determination methods of the PRB index of the PUCCH resource are illustrated as below when frequency hopping is not performed (enabled) for the cell specific PUCCH transmission.

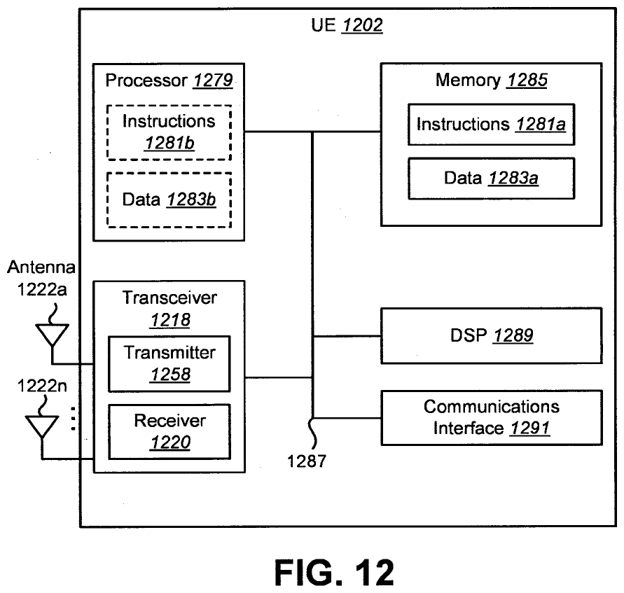

FIG. 12 illustrates various components that may be utilized in a UE 1202. The UE 1202 (UE 102) described in connection with FIG. 12 may be implemented in accordance with the UE 102 described in connection with FIG. 1. The UE 1202 includes a processor 1281 that controls operation of the UE 1202. The processor 1281 may also be referred to as a central processing unit (CPU). Memory 1287, which may include read-only memory (ROM), random access memory (RAM), a combination of the two or any type of device that may store information, provides instructions 1283a and data 1285a to the processor 1281. A portion of the memory 1287 may also include non-volatile random access memory (NVRAM). Instructions 1283b and data 1285b may also reside in the processor 1281. Instructions 1283b and/or data 1285b loaded into the processor 1281 may also include instructions 1283a and/or data 1285a from memory 1287 that were loaded for execution or processing by the processor 1281. The instructions 1283b may be executed by the processor 1281 to implement one or more of the methods described above.

The UE 1202 may also include a housing that contains one or more transmitters 1258 and one or more receivers 1220 to allow transmission and reception of data. The transmitter(s) 1258 and receiver(s) 1220 may be combined into one or more transceivers 1218. One or more antennas 1222a-n are attached to the housing and electrically coupled to the transceiver 1218.

The various components of the UE 1202 are coupled together by a bus system 1289, which may include a power bus, a control signal bus and a status signal bus, in addition to a data bus. However, for the sake of clarity, the various buses are illustrated in FIG. 12 as the bus system 1289. The UE 1202 may also include a digital signal processor (DSP) 1291 for use in processing signals. The UE 1202 may also include a communications interface 1293 that provides user access to the functions of the UE 1202. The UE 1202 illustrated in FIG. 12 is a functional block diagram rather than a listing of specific components.

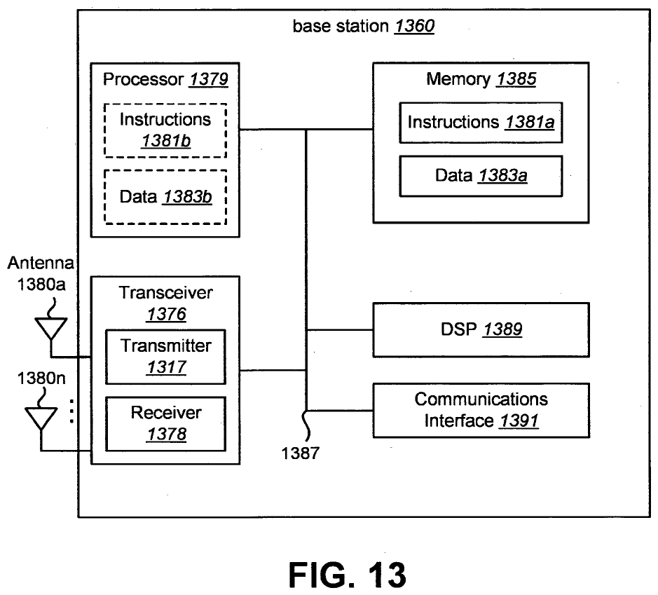

FIG. 13 illustrates various components that may be utilized in a base station 1360. The base station 1360 described in connection with FIG. 13 may be implemented in accordance with the base station 160 described in connection with FIG. 1. The base station 1360 includes a processor 1381 that controls operation of the base station 1360. The processor 1381 may also be referred to as a central processing unit (CPU). Memory 1387, which may include read-only memory (ROM), random access memory (RAM), a combination of the two or any type of device that may store information, provides instructions 1383a and data 1385a to the processor 1381. A portion of the memory 1387 may also include non-volatile random access memory (NVRAM). Instructions 1383b and data 1385b may also reside in the processor 1381. Instructions 1383b and/or data 1385b loaded into the processor 1381 may also include instructions 1383a and/or data 1385a from memory 1387 that were loaded for execution or processing by the processor 1381. The instructions 1383b may be executed by the processor 1381 to implement one or more of the methods 300 described above.

The base station 1360 may also include a housing that contains one or more transmitters 1317 and one or more receivers 1378 to allow transmission and reception of data. The transmitter(s) 1317 and receiver(s) 1378 may be combined into one or more transceivers 1376. One or more antennas 1380a-n are attached to the housing and electrically coupled to the transceiver 1376.

The various components of the base station 1360 are coupled together by a bus system 1389, which may include a power bus, a control signal bus and a status signal bus, in addition to a data bus. However, for the sake of clarity, the various buses are illustrated in FIG. 13 as the bus system 1389. The base station 1360 may also include a digital signal processor (DSP) 1391 for use in processing signals. The base station 1360 may also include a communications interface 1393 that provides user access to the functions of the base station 1360. The base station 1360 illustrated in FIG. 13 is a functional block diagram rather than a listing of specific components.

The term “computer-readable medium” refers to any available medium that can be accessed by a computer or a processor. The term “computer-readable medium,” as used herein, may denote a computer-and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using circuitry, a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

1-11. (canceled)

12. A user equipment (UE), comprising:
reception circuitry configured to receive, from another UE, a physical sidelink shared channel (PSSCH) on one or multiple resource block (RB) sets in a frequency domain, each RB set being defined by a starting common RB and an ending common RB in the frequency domain; and
control circuitry configured to determine, a physical sidelink feedback channel (PSFCH) resource for a HARQ feedback transmission in response to the reception of the PSSCH, wherein
the PSFCH resource in frequency domain corresponds to an interlace within a first RB set, and
the first RB set is determined as an RB set with a lowest RB set index amongst the one or multiple RB sets.

13. The UE according to claim 12, wherein
the PSFCH resource is determined as resource blocks of the interlace within the first RB set.

14. The UE according to claim 12, wherein
the interlace for the PSFCH resource is determined based on a lowest interlace index that is allocated to the PSSCH.

15. A communication method performed by a user equipment (UE), comprising:
receiving, from another UE, a physical sidelink shared channel (PSSCH) on one or multiple resource block (RB) sets in a frequency domain, each RB set being defined by a starting common RB and an ending common RB in the frequency domain; and
determining, a physical sidelink feedback channel (PSFCH) resource for a HARQ feedback transmission in response to the reception of the PSSCH, wherein
the PSFCH resource in frequency domain corresponds to an interlace within a first RB set, and
the first RB set is determined as an RB set with a lowest RB set index amongst the one or multiple RB sets.
